(19) United States
(12) Patent Application Publication
(10) Pub. No.: US 2026/0216748 A1
(43) Pub. Date: Jul. 30, 2026

(54) METHODS AND SYSTEMS FOR DETERMINING APPLICATION PARAMETERS FOR A COATING PROCESS

(71) Applicant: BASF COATINGS GMBH, Muenster (DE)

(72) Inventors: Fernando BONIFAZ CONSTANTINO, Shanghai (CN); Jens WEGNER, Muenster (DE); Georg WIGGER, Muenster (DE); Lisa WEIBRECHT, Muenster (DE); Jin Long XU, Shanghai (CN); Dirk EIERHOFF, Muenster (DE)

(21) Appl. No.: 19/143,504

(22) PCT Filed: Jan. 10, 2023
(86) PCT No.: PCT/CN23/71727

§ 371 Date: Jun. 26, 2025

(51) Int. Cl. B05C 21/00; G05B 13/04

(52) U.S. Cl. CPC B05C 21/00; G05B 13/042

(57) ABSTRACT

Described herein are computer-implemented methods, apparatuses and computer program products for determining application parameters for applying a sample coating material to at least part of a surface of an object such that the resulting sample coating matches the properties of a reference coating. Also described herein are a method and a computer program product for training a data-driven model for determining application parameters for applying a sample coating material to at least part of a surface of an object such that the resulting sample coating matches the properties of a reference coating.

### TECHNICAL FIELD

Aspects described herein generally relate to computer-implemented methods, apparatuses and computer program products for determining application parameters for applying a sample coating material to at least part of a surface of an object such that the resulting sample coating matches the properties of a reference coating. Moreover, aspects described herein relate to a method and a computer program product for training a data-driven model for determining application parameters for applying a sample coating material to at least part of a surface of an object such that the resulting sample coating matches the properties of a reference coating.

### BACKGROUND

Many modern industrial painting processes involve highly complex multi-step processes. For example, automotive, commercial vehicle, aerospace, light & heavy industrial, marine, and others require highly consistent coatings film thickness, final paint colors, visual appearance equal to expectation, cured coatings performance properties equal to specification, across large product lines and over long periods of time. To ensure the aforementioned quality, respective application parameters used for each coating material need to be determined and/or the coating material need to be adapted. These processes are rather time consuming and adjustments of the application parameters and/or modification of the coating material are based on know-how and experience of a specialist. Thus, the use of new coating materials, for example at a painting line, requires a large amount of time and resources.

In view of the aforementioned drawbacks, it would be desirable to provide computer-implemented methods, systems and computer program products which allow to determine suitable application parameters for a coating material application equipment quickly and reliably for a specific coating material without performing extensive application tests requiring human expertise. In case fixed application parameters are used, the computer-implemented method, systems and computer program products should allow to determine a suitable formulation of a coating material which, when applied using the fixed application parameters, fulfils defined specifications, preferably without requiring any tinting expertise.

### SUMMARY

In an aspect, the present disclosure relates to a computer-implemented method for determining application parameters for applying a sample coating material to at least part of a surface of an object such that the resulting sample coating matches the properties of a reference coating. Said method comprises the following steps:
(i) providing to a computer processor via a communication interface
   data associated with the reference coating, said data including property data of the reference coating and respective threshold value(s) for said property data,
   application parameters, wherein the application parameters are randomly generated based on data associated with a coating material application equipment,
   data associated with the sample coating material, and
   at least one data-driven model, wherein each data-driven model is parameterized according to a training dataset, wherein the training dataset is based on sets of training data comprising application parameters, data associated with coatings and data associated with coating materials
(ii) determining, with the computer processor, data associated with the sample coating based on the provided data associated with the sample coating material, the provided application parameters and the provided data-driven model(s),
(iii) determining, with the computer processor, the acceptability of the provided application parameters based on the data determined in step (ii) and the data associated with the reference coating provided in step (i),
(iv) optionally determining optimized application parameters and repeating steps (ii) and (iii) using the determined optimized application parameters; and
(v) providing via the communication interface the randomly generated application parameters or the optimized application parameters.

In another aspect, the present disclosure relates to an apparatus for determining application parameters for applying a sample coating material to at least part of a surface of an object such that the resulting sample coating layer matches the properties of a reference coating layer. The apparatus comprises one or more computing nodes and one or more computer-readable media having thereon computer-executable instructions that are structured such that, when executed by the one or more computing nodes, cause the apparatus, particularly one or more of the computing nodes, perform the inventive method.

In a further aspect, the present disclosure relates to a computer program or computer readable non-volatile storage medium comprising computer readable instructions, which when loaded and executed by a processing device perform the inventive method.

In yet another aspect, the present disclosure relates to a method for training at least one data-driven model for determining application parameters for applying a sample coating material to at least part of a surface of an object such that the resulting sample coating layer matches the properties of a reference coating layer is proposed. Said training method comprises the steps of:
providing, via a communication interface, at least one training dataset based on sets of training data comprising application parameters, data associated with of coatings and data associated with the coating materials used to prepare the coatings,
training, via a processing device, the at least one data-driven model by adjusting the parameterization according to the training dataset(s),
providing, via the communication interface, the trained data-driven model(s).

In a further aspect, the present disclosure relates to a computer program product or computer readable non-volatile storage medium comprising at least one data-driven model trained according to the inventive training method is disclosed.

In yet another aspect, the present disclosure relates to a system including
a sample coating material and
application parameters for applying the sample coating material to at least part of the surface of an object such that the resulting sample coating layer matches the properties of a reference coating layer, wherein said application parameters are determined according to the inventive method for determining application parameters.

In yet another aspect, the present disclosure relates to a client device for generating a request to initiate the determination of application parameters for applying a sample coating material to at least part of a surface of an object such that the resulting sample coating layer matches the properties of a reference coating layer at a server device is disclosed. Said client device is configured to provide data associated with the reference coating, application parameters and data associated with the sample coating material to the server device. The server device is an apparatus as disclosed herein.

The methods, apparatuses, systems, client devices and computer-elements disclosed herein allow for quick and reliable determination of application parameters which are necessary to apply a sample coating material to a substrate such that the properties of the resulting sample coating fulfil required specifications, i.e. match the properties of a reference coating. This renders the manual steps of determining suitable application parameters to apply a specific coating material to a substrate superfluous and thus allows to perform the introduction of a new coating material at a painting line more efficient. Moreover, the number of experiments necessary to determine suitable application parameters or coating material composition can be reduced significantly. Additionally, a modified formulation of the coating material may be determined in case the determined application parameters do not match a defined set of application parameters. This significantly reduces the number of trials necessary to determine the modifications of a coating material which are necessary to achieve the desired surface properties for a given set of application parameters. Moreover, this increases the flexibility, because it allows to vary the application parameters or to use fixed application parameters.

### EMBODIMENTS

In the following, terminology as used herein and/or the technical field of the present disclosure will be outlined by ways of embodiments and/or examples. Where examples are given, it is to be understood that the present disclosure is not limited to said examples.

In an embodiment, application parameters may refer to parameters necessary for applying a sample coating material to an object using a defined coating material application equipment and/or a defined coating process, such as a pneumatic or electrostatic coating material application equipment, and/or to data being indicative of the coating material application equipment, such as the type/model of the atomizer and/or the type/model of the shaping air ring and/or the type/model of the bell cup or air cap. Parameters necessary for applying a sample coating material to an object using a defined coating material application equipment may include shaping air value(s), flow rate, bell speed, high voltage, distance to object, distance to track, traction speed or a combination thereof.

In an embodiment, reference coating layer may refer to a coating layer having at least one property, such as defined colorimetric properties, that is to be matched in comparison with a sample coating layer produced using the determined application parameters.

In an embodiment, reference coating material may refer to a coating material used to prepare the reference coating layer, i.e. a coating material resulting in a coating layer that is identical or similar in characteristics to the reference coating layer to be matched. The reference coating layer and corresponding reference coating material may be selected by entering data being indicative of the reference coating material used to prepare the reference coating layer, such as the color name, color number or product code of said material or by entering data being indicative of the object coated with said reference coating layer, such as the vehicle VIN.

In an embodiment, sample coating layer may refer to a coating layer produced using the application parameters determined with the method disclosure herein that is evaluated in comparison with the target coating layer.

In an embodiment, properties of the sample coating matching the properties of the reference coating may denote a difference between the color data associated with the sample coating and the color data associated with the reference coating below a defined threshold. The difference may be a color difference. The color difference may be determined using color tolerance equations. The threshold value may be selected such that no visible difference in terms of color and/or effect may be detectable by the human eye.

In an embodiment, sample coating material may refer to a coating material used to prepare the sample coating layer.

In an embodiment, coating material may refer to a mixture of chemical components that will form a coating when applied to at least part of the surface of an object and optionally dried and/or cured after application. Drying and/or curing may be performed at elevated temperatures.

In an embodiment, coating material application equipment may refer to a device which is used to apply a liquid or solid coating material to a least part of the surface of an object, in particular via a spraying process.

In an embodiment, liquid sample coating material may refer to a sample coating material having a liquid aggregate state under conditions used during the application of the sample coating material.

In an embodiment, solid sample coating material nay refers to a sample coating material having a solid aggregate state under conditions used during application of the sample coating material. In one example, the sample coating material may be a liquid primer-surfacer material, a liquid primer material, a liquid basecoat material, a liquid tinted clearcoat material or a liquid clearcoat material. In an embodiment, primer-surfacer material may refer to a sample coating material used to produce an intermediate layer filling out the irregularities of the object, to support corrosion resistance and adhesion as well as to provide protection from mechanical exposure such as stone chipping. In an embodiment, primer material may refer to a sample coating material used to provide improved adhesion for further coating layers to be applied and improved corrosion protection, for example on metallic substrates. In an embodiment, basecoat material may refer to a color-imparting sample coating material used to produce a colored intermediate coating layer. The basecoat material may be formulated as a solid color (straight shade) or effect color sample coating material. In an embodiment, effect color sample coating materials may refer to coating materials containing at least one effect pigment and optionally other colored pigments or spheres which give the desired color and effect. In an embodiment, straight shade sample coating materials or solid color coating materials may refer to coating materials primarily containing colored pigments and exhibit no visible flop or two-tone metallic effect. In an embodiment, tinted clearcoat material may refer to a sample coating material which is neither completely transparent and colorless as a clear coating material nor completely opaque as a typical pigmented basecoat material. A tinted clearcoat material is therefore transparent and colored or semi-transparent and colored. The color can be achieved by adding small amounts of pigments commonly used in basecoat materials.

In an embodiment, coating layer may refer to a single coating layer or to a multilayer coating comprising at least two coating layers. The at least two coating layers may have been prepared from the same coating material or from different coating materials. In one example, the sample coating layer and the reference coating layer each comprise at least two coating layers, such as a basecoat layer prepared from a basecoat material and a clearcoat layer prepared from a clearcoat material. In that case, the clearcoat material may be applied using defined application parameters such that only the application parameters for application of the sample basecoat material may be determined.

In an embodiment, object may refer to any object that is desired to be coated with a coating layer. The object may be a vehicle or a part thereof, such as an exterior surface or an interior surface of a vehicle. Vehicles may include automobiles, buses, vans, trucks, motorcycles, buses, heavy trucks, trailers, road paving machinery, tractors, bulldozers, cranes, combines, graders, locomotives, rail cars, snow mobiles, all-terrain vehicles, wagons, buggies, bicycles, watercraft, aircraft and other modes of transport that are commonly coated with at least one coating layer.

In an embodiment processor may refer to a circuitry configured to perform basic operations of a computer or system, and/or, generally, to a device which is configured for performing calculations or operations. In particular, the processor, or computer processor may be configured for processing basic instructions that drive the computer or system. It may be a semi-conductor based processor, a quantum processor, or any other type of processor configures for processing instructions. As an example, the processor may be or may comprise a Central Processing Unit (“CPU”). The processor may be a (“GPU”) graphics processing unit, (“TPU”) tensor processing unit, (“CISC”) Complex Instruction Set Computing microprocessor, Reduced Instruction Set Computing (“RISC”) microprocessor, Very Long Instruction Word (“VLIW”) microprocessor, or a processor implementing other instruction sets or processors implementing a combination of instruction sets. The processing means may also be one or more special-purpose processing devices such as an Application-Specific Integrated Circuit (“ASIC”), a Field Programmable Gate Array (“FPGA”), a Complex Programmable Logic Device (“CPLD”), a Digital Signal Processor (“DSP”), a network processor, or the like. The methods, systems and devices described herein may be implemented as software in a DSP, in a micro-controller, or in any other side-processor or as hardware circuit within an ASIC, CPLD, or FPGA. It is to be understood that the term processor may also refer to one or more processing devices, such as a distributed system of processing devices located across multiple computer systems (e.g., cloud computing), and is not limited to a single device unless otherwise specified. In an example, a processor may also be seen as a subpart of a processor wherein this subpart is executing the method in form of a thread, a container and/or a virtual machine.

In an embodiment, communication interface may refer to a software and/or hardware interface for establishing communication such as transfer or exchange or signals or data. Software interfaces may be e. g. function calls, APIs. Communication interfaces may comprise transceivers and/or receivers. The communication may either be wired, or it may be wireless. Communication interface may be based on or it supports one or more communication protocols. The communication protocol may a wireless protocol, for example: short distance communication protocol such as Bluetooth®, or WiFi, or long distance communication protocol such as cellular or mobile network, for example, second-generation cellular network (“2G”), 3G, 4G, Long-Term Evolution (“LTE”), or 5G. Alternatively, or in addition, the communication interface may even be based on a proprietary short distance or long distance protocol. The communication interface may support any one or more standards and/or proprietary protocols.

In an embodiment memory may refer to a physical system memory, which may be volatile, non-volatile, or a combination thereof. The memory may include non-volatile mass storage such as physical storage media. The memory may be a computer-readable storage media such as RAM, ROM, EEPROM, CD-ROM, or other optical disk storage, magnetic disk storage, or other magnetic storage devices, non-magnetic disk storage such as solid-state disk or any other physical and tangible storage medium which can be used to store desired program code means in the form of computer-executable instructions or data structures and which can be accessed by the computing system. Moreover, the memory may be a computer-readable media that carries computer-executable instructions (also called transmission media). Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing components that also (or even primarily) utilize transmission media.

In an embodiment, a computing node may refer to any device or system that includes at least one physical and tangible processor, and a physical and tangible memory capable of having thereon computer-executable instructions that are executed by a processor. Computing nodes may, for example, be handheld devices, production facilities, sensors, monitoring systems, control systems, appliances, laptop computers, desktop computers, mainframes, data centers, or even devices that have not conventionally been considered a computing node, such as wearables (e.g., glasses, watches or the like). The memory may take any form and depends on the nature and form of the computing node.

In an embodiment, data-driven model may refer to a model at least partially derived from data. Use of a data-driven model can allow describing relations, that cannot be modelled by physico-chemical laws, i.e. allow to describe relations without solving equations from physico-chemical laws. This can reduce computational power and can improve speed. The data-driven model is derived from Machine Learning (Machine Learning and Deep Learning frameworks and libraries for large-scale data mining: a survey, Artificial Intelligence Review 52, 77-124 (2019), Springer) and preferably comprises empirical or so-called “black box models”. Empirical or “black box” model may refer to models being built by using one or more of machine learning, deep learning, or other form of artificial intelligence. The empirical or “black box” model may be any model that yields a good fit between training and test data.

In an embodiment, training data may refer to data sets including application parameters, property data of the coating layer, and optionally data on the physical properties of the coating material used to prepare the coating layer, wherein each data set is associated with a single application process. Hence each data set includes data associated with the application process of the coating material, the property of the coating layer resulting from the application process and optionally the physical properties of the coating material used in the application process. Such data may be measured and recorded during the application process of the coating material, upon determining the properties of the coating layer resulting from the application process and optionally after production of the coating material used in the application process. At least part of the data may be simulated using suitable simulation methods. Apart from the measured or recorded application parameters, the training data may also contain a range of suitable application parameters associated with the respective coating material application equipment.

In an embodiment, client device may refer to a computer or a program that, as part of its operation, relies on sending a request to another program or a computer hardware or software that accesses a service made available by a server. The server may or may not be located on another computer.

In an embodiment, texture characteristics may refer to the coarseness characteristics and/or sparkle characteristics of an effect coating layer. The coarseness characteristics and the sparkle characteristics of effect coating layers may be determined from texture images acquired by multi-angle spectrophotometers according to procedures well known in the state of the art. The terms “graininess”, “coarseness”, “coarseness characteristics” and “coarseness values” are used as synonyms within the description.

In an embodiment, database may refer to a collection of related information that can be searched and retrieved. The database can be a searchable electronic numerical, alphanumerical, or textual document; a searchable PDF document; a Microsoft Excel® spreadsheet; or a database commonly known in the state of the art. The database can be a set of electronic documents, photographs, images, diagrams, data, or drawings, residing in a computer readable storage media that can be searched and retrieved. A database can be a single database or a set of related databases or a group of unrelated databases. “Related database” means that there is at least one common information element in the related databases that can be used to relate such databases.

In an embodiment, machine learning may refer to computer algorithms that improve through experience and build on a model based on sample data, often described as training data, utilizing supervised, unsupervised, or semi-supervised machine learning techniques. Supervised learning includes using training data having a known label or result and preparing a model through a training process in which it is required to make predictions and is corrected when those predictions are wrong. The training process continues until the model achieves a desired level of accuracy on the training data. Semi-supervised learning includes using a mixture of labelled and unlabelled input data and preparing a model through a training process in which the model must learn the structures to organize the data as well as make predictions. Unsupervised learning includes using unlabelled input data not having a known result and preparing a model by deducing structures, such as general rules, similarity, etc., present in the input data.

In an embodiment, computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention. In an embodiment, computer readable program instructions may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device may receive the computer readable program instructions from the network and may forward the computer readable program instructions for storage in a computer readable storage medium within the respective computing/processing device.

In conventional coatings, each of the coating layers within the coating may be additive and build upon one another. Additionally, many of the layers may be polychromatic color and clear finishes. As such, it is increasingly difficult and important to ensure that each layer is consistent across the process so that the final product has the correct coating attributes. For example, a single car may be painted with multiple different layers in order to provide significant corrosion protection and create a very specific final color and effect. A significant discrepancy within any of the layers may result in a final paint color that does not meet the specifications and that does not match the other cars, or final cure film performance that does not meet quality or durability specifications.

Additionally, conventional coatings often require unique paint formulations for different application parameters in order to create coating systems that have the required specifications and/or attributes. For example, every use of a new coating material in a customer painting line requires testing of the coating material at the painting line to identify suitable application parameters or to identify the product performance under the application parameters such that the coating material formulation can be adapted, for example by tinting, if necessary. Currently, identification of suitable application parameters is done by the following process:
determining application parameters at the coating material manufacturing site,
applying the coating material using the determined application parameters,
drying and/or curing the applied coating material to form a coating layer, determining the properties of the formed coating layer, such as the color and/or texture characteristics, and
comparing the determined properties to required specifications.

If the required specifications are fulfilled, the coating material is applied using the determined application parameters at the customer's coating line and the properties of the resulting coating layer are compared to the required specifications. If the required specifications are not fulfilled, the whole process has to be repeated by determining new application parameters and/or by adapting the formulation of the coating material, for example by tinting.

In case application parameters used at the customer's painting line are fixed—i.e. they cannot be varied upon use of a new coating material in the painting line—it has to be determined whether the coating material fulfils the required specifications upon application of the coating material using the fixed application parameters and if not, the formulation of the coating material has to be adjusted accordingly. For this purpose, the respective coating material is normally applied using the fixed application parameters and the specifications of the coating layer obtained upon application of the coating material are determined and compared to the required specifications. In case the required specifications are not met, the formulation of the coating material is adapted, for example by tinting, and the application process is repeated. If the required specifications are fulfilled, the coating material or modified coating material is tested in the customer's painting line. In case the required specifications are not met using the customer's painting line, the whole process has to be repeated.

Hence, there is a need to provide methods, systems and computer program elements which allow to reliably determine suitable application parameters for a given coating material or a suitable coating material composition for a given set of application parameters without requiring extensive experiments.

These and other objects, which become apparent upon reading the following description, are solved by the subject matters of the independent claims. The dependent claims refer to preferred embodiments of the invention.

The method for determining application parameters as disclosed herein allows to determine application parameters for applying a sample coating material to at least part of the surface of an object such that the resulting sample coating layer, i.e. the sample coating layer resulting from applying the sample coating material using the determined application parameters and optionally drying and/or curing the applied sample coating material, matches the properties of a reference coating layer.

The application parameters may be determined for at least part of the sample coating materials used to prepare the sample coating. For instance, the sample coating may comprise a basecoat layer and a clearcoat layer and the application parameters may only be determined for the basecoat material used to prepare the basecoat layer with the method disclosed herein while commonly known application parameters may be used for the clearcoat material.

In one embodiment, the determined application parameters include application parameters for a coating material application equipment and/or data associated with a coating material application equipment and/or data associated with a coating process. Application parameters for the coating material application equipment may include shaping air value(s), flow rate, bell speed, high voltage, distance to object, distance to track, traction speed or a combination thereof. The coating material application equipment may be the coating material application equipment linked with the provided data associated with the coating material application equipment. Data associated with the coating material equipment may include the manufacturer, model, year of manufacturing, atomizer type/model, shaping air ring type/model, bell cup or air cap type/model, etc. To determine application parameters for a coating material equipment, a specific coating material application equipment may be defined. Definition of the coating material application equipment may be achieved by providing data associated with said coating material application equipment, i.e. data which is indicative for said equipment. Data associated with the coating material equipment may be determined after determining suitable application parameters. For instance, data associated with a suitable coating material equipment may be determined by retrieving said data from a database based on the determined application parameters. Said database may contain application parameters interrelated with data associated with coating material equipment.

Suitable coating material application equipment includes pneumatic or electrostatic coating material application equipment, in particular electrostatic coating material application equipment. In this respect, it is preferred if the coating material application equipment comprises at least one atomizer, at least one shaping air ring, at least one bell and at least one nozzle. If the coating material application equipment is a pneumatic coating material application equipment, said equipment preferably comprises at least one atomizer and at least one nozzle.

The sample coating material may be a liquid or solid sample coating material. The sample coating material may be a liquid primer-surfacer material, a liquid primer material, a liquid basecoat material, a liquid tinted clearcoat material or a liquid clearcoat material.

The object be a vehicle or a part thereof. For instance, the object may be an automotive or a part thereof. The object may be a plate or sheet. The object may comprise metal and/or plastic.

In one embodiment, data associated with the reference coating comprises color data obtained for at least one measurement geometry using at least one illuminant, gloss-horizontal, gloss-vertical, distinctness of image-horizontal (DOI-H), DOI-vertical; peel-horizontal, peel-vertical, OAR-horizontal, OAR-vertical, pop value, sag value, pinholing value, wet and/or dry film thickness, or any combination thereof. OAR-horizontal and OAR-vertical properties can be obtained from the respective gloss, DOI and peel values.

The color data may be obtained at at least two measurement geometries using at least one illuminant. The measurement geometries may include aspecular angles of −50 to 150°, preferably of −15° to 110°, in particular of −15°, 15°, 25°, 45°, 75° and 110°. The aspecular angle is the difference between the viewing angle and the specular (mirror-like) reflection angle of the illuminant. Aspecular angles of up to 30°, for example of 10° to 30°, are also referred to as “gloss measurement geometries” because these aspecular angles allows to measure the gloss color produced by the effect pigments present in the target coating layer. Aspecular angles of more than 30° to 70° are also referred to as “intermediate measurement geometries” and aspecular angles of more than 70°, for example of 70° to 110°, are also referred to as “flop measurement geometries” and allow to measure the angle-dependent color change of effect pigments present in the respective coating. Such color data can, for example, be obtained using a multi-angle spectrophotometer, such as, for example, a Byk-Mac I® with six measurement geometries (i.e. a fixed illumination angle and viewing/measurement angles of −15°, 15°, 25°, 45°, 75°, 110°), an X-Rite MAT12® with twelve measurement geometries (two illumination angles and six measurement angles), or an X-Rite MA 98® (two illumination angles and up to eleven measurement angles).

The color data may include colorimetric values, such as CIEL*a*b* values and/or CIEL*C*h*, texture characteristics and/or data calculated from the color data. Data calculated from the color data may refer to data, such as flop values, which is calculated using color data, such as CIEL*a*b* values or CIEL*C*H* values determined at a plurality of measurement geometries.

Respective threshold values(s) for the data may comprise color difference values for each measurement geometry and each used illuminant included in the data associated with the reference coating, such as each measurement geometry and each used illuminant associated with the color data included in said data.

In one embodiment, the data associated with the reference coating further includes data associated with the reference coating material used to prepare the reference coating, data associated with a production site producing the reference coating, data associated with the coating material application equipment, defined set(s) of application parameters, or a combination thereof. Data associated with the reference coating material may, for example, include a color number, a color name, a product code, a bar code, a QR code, a unique color ID, or a combination thereof. Data associated with the production site may include, for example, the name of the site where the reference coating was produced from the reference coating material, the address of the production site, GPS data of the production site or a combination thereof. Data associated with the coating material application equipment may, for example, include the name of the equipment, the manufacturer of the equipment, the manufacturing year, the atomizer type/model, the shaping air ring type/model, the bell cup or air cap type/model, the nozzle type/model/size or a combination thereof. Defined set(s) of application parameters may include application parameters associated with the coating material application equipment for applying the reference coating material to at least part of the surface of the object, such as the shaping air value(s), flow rate, bell speed, high voltage, distance to object, distance to track, traction speed or a combination thereof.

Data associated with the reference coating may be stored on a data storage medium. The data storage medium may be an internal storage present in a device housing the processor or may be stored in a database. The database may be connected via a communication interface to the processor.

The stored data associated with the reference coating may be interrelated with a reference coating identifier to allow retrieval of said data based on the reference coating identifier. The identifier may, for example, be data associated with the reference coating material used to prepare the reference coating layer as described previously, such as a color name and/or a product code and/or a QR code and/or a bar code and/or a unique color ID.

The data associated with the reference coating may be provided by manually inputting the respective data. The data associated with the reference coating may be provided by importing the respective data from a computer readable medium, such as a file, a database or a cloud storage. The data associated with the reference coating may be provided using a measuring device, such as a spectrophotometer. A GUI may be used to facilitate data input, for example by providing adjustment tools which can be used to enter the respective data or by providing buttons for data import.

Providing the data associated with the reference coating in step (i) may include providing a reference coating identifier,
retrieving—with the computer processor—the data associated with the reference coating based on the provided reference coating identifier,
optionally displaying the retrieved data on a screen of a display device connected to the processor via a communication interface, and
optionally modifying the displayed data.

Display of the retrieved data may include displaying the color data, in particular CIEL*a*b* and/or CIEL*C*h* values and/or texture characteristics, obtained for a plurality of measurement geometries using at least one illuminant, the threshold value(s) or a combination thereof. The color data may be displayed on the screen of the display device, for example within a GUI present on the screen of the display device. Display of the color data allows to modify the displayed data by the user, thus allowing to adapt the retrieved data prior to determination of the application parameters.

The displayed data may be modified by entering new values in the respective data fields. The displayed data may be modified by manipulating at least one regulator of an adjustment tool displayed in the GUI of the screen of the display device. Adjustment tool may refer to a part of a graphical user interface which allows to modify at least part of the data associated with the reference coating. The adjustment tool may comprise at least one regulator for each colorimetric value determined at each measurement geometry for each illuminant such that said retrieved color data may be displayed via the adjustment tools by setting the regulator to a position corresponding to said retrieved color data. Modifying may then be performed by a user by moving at least one regulator, for example via a computer mouse or a finger (in case the display includes a touchscreen), of the adjustment tool. In addition to displaying at least one regulator, numerical value(s) may be displayed for the respective data associated with the regulator. This value(s) may be automatically updated in response to moving the regulator to provide an interactive guidance of the modification to the user.

In one embodiment, data associated with the coating material application equipment comprises a range or a specific value for at least one parameter selected from shaping air value(s), flow rate, bell speed, high voltage, distance to object, distance to track and traction speed. The range for the at least one parameter may be based on technical limitations of said coating material application equipment and/or parameters commonly used for said coating material application equipment. The specific value may be defined by the user as described below. The data associated with the coating material application equipment may be stored on an internal memory or a database. The stored data associated with the coating material application equipment may be interrelated with coating application equipment identifier(s) to allow retrieval of said data based on the coating application equipment identifier(s). The identifier(s) may, for example, be data as associated with the application process, the atomizer type/model, the shaping air ring type/model, the bell cup or air cap type/model, equipment ID, etc.

In one embodiment, randomly generating the application parameters includes providing data associated with the coating material application equipment and randomly generating the application parameters based on the provided data. The application parameters may be generated with the computer processor implementing the method as disclosed herein. Proving data associated with the coating material equipment may include
providing at least one coating application equipment identifier,
retrieving—with the computer processor—the data associated with the coating material application equipment based on the provided at least one coating application equipment identifier,
optionally displaying the retrieved data on a screen of a display device connected to the processor via a communication interface, and
optionally modifying the displayed data.

For instance, data associated with the application process, the atomizer type/model, the shaping air ring type/model and the bell cup or air cap type/model may be provided as coating application equipment identifier, for example by entering the respective data into fields present on the GUI or by selecting available data from a drop-down menu present on the GUI. The processor may then retrieve the respective data from the data storage medium. Display of the ranges of parameters contained in the retrieved data allows to modify the displayed data by the user, thus allowing to adapt the retrieved data prior to determination of the application parameters. Moreover, the user may select whether a parameter range or a defined parameter value is used for determination of the application parameters. Use of a defined parameter may be preferred if, for example, the application process requires said defined parameter.

In another instance, only data associated with the application process is used as coating material application equipment identifier to retrieve the data associated with the coating material application equipment.

In yet another instance, an equipment ID is used to retrieve the data associated with the coating material equipment.

The displayed data may be modified by entering new values in the respective data fields or by manipulating at least one regulator of an adjustment tool displayed in the GUI of the screen of the display device as described previously. The adjustment tool may comprise one modulator for each end point (i.e. minimum and maximum value) of the parameter range contained in the retrieved data. Modifying may then be performed by a user by moving at least one regulator, for example via a computer mouse or a finger (in case the display includes a touchscreen), of the adjustment tool. In addition to displaying at least one regulator, numerical value(s) may be displayed for the respective data associated with the regulator. This value(s) may be automatically updated in response to moving the regulator to provide an interactive guidance of the optimizing process to the user. Selection of a defined value may be accomplished by moving the regulator to the desired position and selecting that this value is to be used as fixed value, for example by marking an appropriate checkbox being displayed next to the adjustment tool.

The application parameters may be generated from a range or a specific value contained in the data associated with the coating material application equipment. The range or specific value may be selected for at least one parameter including shaping air value(s), flow rate, bell speed, high voltage, distance to object, distance to track and traction speed. The application parameters may correspond to the parameters used to apply the sample coating material to an object using the coating material application equipment linked to the provided data associated with the coating material application equipment.

In an embodiment, the application parameters are randomly generated using uniform sampling methods. Uniform sampling methods are well known in the state of the art and are used to perform samplings at random within a given domain following a uniform distribution. The given domain may correspond to the range or value(s) for the above-mentioned parameters.

In an embodiment, the data associated with the sample coating comprises a number being indicative of the sample coating material used to prepare the sample coating, physical properties of the sample coating material used to prepare the sample coating, chemical properties of the sample coating material used to prepare the sample coating, the film thickness of the sample coating or a combination thereof. The number being indicative of the sample coating material may be a numerical integer. Physical properties of the sample coating material may include the viscosity, the solid contents, the density, the technology/chemistry, the number/amount of adjustments of the sample coating material, the shear history, the processing temperature, the storage time/temperature or a combination thereof. The technology/chemistry may, for example, include information on whether the sample coating material is a water-borne or solvent-borne coating material, how the sample coating material has been produced, etc., Chemical properties of the sample coating material may include the pigment-to-binder ratio, the formulation of the sample coating material or a combination thereof. The film thickness of the sample coating may correspond to the dry film thickness of the sample coating obtained after applying the respective sample coating material to an object, optionally drying the applied sample coating material and curing the sample coating material. The film thickness may be a single numerical value or a range. The data associated with the sample coating material may be stored on an internal memory or a database, as described previously and may be interrelated with a sample coating identifier to facilitate retrieval of said data from the data storage medium. The sample coating identifier may be the color name and/or the product code and/or the unique ID associated with the sample coating material used to prepare the sample coating. The sample coating identifier may be equal to the reference coating identifier.

Providing the data associated with the sample coating may include the same steps as previously described in relation to providing the data associated with the reference coating. The retrieved data may be displayed on the GUI and may be modified by the user, for example by changing the displayed values, such as the film thickness. The retrieved and displayed data may be modified by entering a new value. The retrieved and displayed data may be modified by using a displayed adjustment tool.

Providing the data associated with the sample coating may include entering respective values, such as the film thickness, into appropriate input fields displayed in a GUI.

Each provided data-driven model is parameterized according to a training data set, i.e. trained using said training data set. The training dataset is based on sets of training data comprising application parameters, data associated with coating(s) and optionally data associated with the coating materials. The coating materials may be used to prepare the coating(s) or may be used to prepare at least part of the coatings, such as one or more coating layers present within the coating. The application parameters may include the parameters necessary to apply the coating material to an object using a coating material application equipment. The application parameters may include a range for each parameter necessary to apply the coating material to the object using the coating material application equipment. The application parameters may include data being indicative of said equipment. The application parameters may include data on the application process. The data associated with the coating(s) may include color data, such as the color data described previously in relation to the property data contained in the data associated with the reference coating, and the dry film thickness of the coating. Data associated with the coating material may include the viscosity, the solid contents, the density, the technology/chemistry, the number/amount of adjustments, the shear history, the processing temperature, the storage time/temperature or a combination thereof.

Each data-driven model may be stored on an internal storage. Each data-driven model may be stored in a database. Each data-driven model may be stored on a remote server or a cloud server. By locating the data-driven model(s) on a remote server or a cloud server, costs of added memory and/or a more complex processor in using the data-driven model(s) to determine the data associated with the sample coating can be avoided. Additionally, continuous, or periodic improvement of the data-driven model(s) may more easily be done on a centralized server and avoids data costs and risks of pushing out a firmware update of the data-driven model(s) to each processor using said model(s). A remote server may also serve as a central repository for storing training data which may be used to train and develop existing data-driven model(s). For example, a growing repository of training data can be used to update and improve existing data-driven model(s) and to provide improved data-driven model(s) for future use.

Retrieval of the respective data-driven model(s) by the processor may be accomplished based on the data contained in the data associated with the reference coating. For instance, the respective data-driven model(s) may be retrieved based on measurement geometries associated with the color data stored in the data associated with the reference coating.

In an embodiment, a plurality of data-driven models is provided in step (i), each data-driven model being parametrized on sets of training data comprising application parameters, data associated with coatings and optionally data associated with the coating materials. The coating materials may be used to prepare the coating(s) or at least a part thereof. The data associated with sample coatings may be selected from color data, such as CIEL*a*b* and/or CIEL*C*h* values, determined at a defined measurement geometry using a defined illuminant. For instance, the defined measurement geometry may correspond to exactly one aspecular angle contained in the data associated with the reference coating. The use of a separate data-driven model for each aspecular angle used to determine the color data contained in the data associated with the reference coating results in a more accurate determination of the data associated with the sample coating using the randomly generated application parameters.

In one embodiment, each data-driven model corresponds to a trained machine learning algorithm. The machine learning algorithm may be trained by selecting inputs and outputs to define an internal structure of the machine learning algorithm, applying a collection of input and output data samples to train the machine learning algorithm, verifying the accuracy of the machine learning algorithm by applying input data samples of known data associated with the sample coating comparing the produced output values with expected output values, and modifying the parameters of the machine learning algorithm using an optimizing algorithm in case the received output values are not corresponding to the data associated with the sample coating. As inputs, the previously described application parameters, data associated with coatings and optionally data associated with the coating material may be used. The input data may be selected randomly but with the proviso that the training data contains the complete spectra of available data associated with coatings, coating materials and their associated application parameters. The produced output values may be color data, such as CIE*L*a*b and/or CIEL*C*h* values for aspecular angles of −50 to 150°. For instance, the aspecular angles may range from −15° to 110°, in particular of −15°, 15°, 25°, 45°, 75° and 110°. Suitable machine learning algorithms include (i) deep learning algorithms, such as Long Short-Term Memory (LSTM) algorithms, or Gated Recurrent Unit (GRU) algorithms, or perceptron algorithms, (ii) instance-based algorithms, such as support vector machines (SVMs), (iii) regression algorithms, such as linear regression algorithms, or (iv) ensemble algorithms, such as gradient boosting machines (GBMs), gradient boosting regression trees (GBRTs), random forests or a combination thereof. With particular preference, each data-driven model is a trained ensemble algorithm, such as a collection of gradient boosting regression trees. “Deep learning” may refer to methods based on artificial neural networks (ANNs) having an unbounded number of layers of bounded size, which permits practical application and optimized implementation, while retaining theoretical universality under mild conditions. Deep learning architectures implementing deep learning algorithms may include deep neural networks, deep belief networks (DBNs), recurrent neural networks (RNNs) and convolutional neural networks (CNNs). In Ensemble Learning, an ensemble (collective of predictors) is formed to produce an ensemble average (collective mean). The predictors can be identical algorithms having different parameters, such as several k nearest neighbour classifiers having different k values and dimension weights, or can be different algorithms which are all trained on the same problem. In prediction, either all algorithms are treated equally or weighted differently. According to an ensemble rule, the results of all algorithms are aggregated, in case of classification by a majority decision, in case of regression mostly by averaging or (in case of stacking) by another regressor. Combination of the algorithms in the ensemble may be performed by the following kinds of meta algorithms: bagging, boosting, or stacking. Bagging considers homogeneous weak learners (i.e. the same algorithm), learns them independently from each other in parallel and combines them following some kind of deterministic averaging process. Boosting often considers homogeneous weak algorithms, learns them sequentially in a very adaptative way (i.e. the weights are adjusted during multiple runs) and combines them following a deterministic strategy. The idea of stacking is to learn several different weak learners and combine them by training a meta-model, such as a neural network, to output predictions based on the multiple predictions returned by these weak models. Stacking is especially useful when the results of the individual algorithms vary greatly, which is almost always the case in regression since continuous values instead of a few classes are outputted.

The training dataset may be obtained by combining application parameters, such as specific values and/or of application parameters, and/or data associated with the used coating material equipment (i.e. the coating material application equipment during the application of the respective coating material) with data associated with the coating (i.e. the coating obtained from applying the coating material) and data associated with the coating material. The training data set may be fully divided, i.e. the complete training data set is divided and used for training. The training data set may be randomly used, i.e. some data is used multiple times, while other data is not used at all. The training data may also be split such that the data splitting does not overlap (also called pasting). Accordingly, each algorithm is trained with specific training data, i.e. is trained independently from the other algorithms. The weights may be adjusted in the direction of the prediction error, i.e. incorrectly predicted data sets are weighted higher in the next run, or in the opposite direction of the prediction error (also known as gradient boosting). Suitable optimization algorithms to manipulate the parameters of the learning algorithm(s) during training may include, for example, gradient descent, momentum, rmsprop, newton-based optimizers, adam, BFGS or model specific methods. These optimizing algorithms may be used during training of the machine learning algorithm to modify the parameters in each training step such that the difference between the output of the machine learning algorithm and the expected output is decreased until a predefined termination criterium, such as number of iterations or accuracy, is obtained.

In an embodiment, determining the data associated with the sample coating includes determining colorimetric values, such as CIEL*a*b* and/or CIEL*C*h* values, for each measurement geometry contained in the data associated with the reference coating provided in step (i).

In an embodiment, determining the acceptability of the provided application parameters based on the determined data associated with the sample coating and the provided data associated with the reference coating includes:
determining the difference(s) between the provided data associated with the reference coating and the determined data associated with the sample coating,
optionally aggregating the determined difference(s) into a single numerical value, and
comparing the determined differences(s) or the single numerical value to the threshold values(s) contained in the provided data associated with the reference coating or to threshold value(s) calculated from the provided data associated with the reference coating.

Determining the difference(s) between the provided data associated with the target coating and the determined data associated with the sample coating may include determining the color difference(s) between the provided color data the each determined color data. The color difference(s) may be determined for each measurement geometry of the plurality of measurement geometries, and/or for each illuminant used to define color difference values. For instance, if the provided data associated with the target coating contains CIEL*a*b* and/or CIEL*C*h* values for six measurement geometries, such as aspecular angles of −15°, 15°, 25°, 45°, 75° and 110°, and different illuminants, the color difference values for the L* value, the a* value and the b* value and/or for the L* value, the C*value and the h*value at each aspecular angle and/or for each illuminant may be determined, respectively. The color difference(s) may be determined using weighted color difference formulae, such as for example described in DIN 6175-1:2009-07 or described in Manuel Melgosa et. al., “Measuring color differences in automotive samples with lightness flop: A test of the AUDI2000 color-difference formula”, pages 3458 to 3467, Optical Society of America, vol. 22, 2004.

Determining the difference(s) between the provided data associated with the target coating and the determined data associated with the sample coating may include determining sparkle differences and graininess differences.

Determining the difference(s) between the provided data associated with the target coating and the determined data associated with the sample coating may include determining the color difference(s) as described above and determining sparkle differences and graininess differences.

Aggregating the determined differences, such as the determined color difference values, into a single numerical value may include calculating an average difference by summing up all determined difference(s), such as color difference values, and dividing the sum by the number of determined difference values.

Aggregating the determined differences, such as the determined color difference values and/or sparkle differences and graininess differences, into a single numerical value may include assigning a single numerical value to a group of characteristic values calculated from respective standardized color difference values and/or sparkle differences and graininess differences using an assignment rule provided in advance.

The determined color, sparkle and graininess differences may be standardized using, for example, the following formula:

$$< Δ {X}^{*} > = \frac{Δ {X}^{*}}{{S}_{x}}$$

in which
<ΔX*> is the standardized value of a respective variable of a color difference, sparkle difference or graininess difference,
ΔX* is the respective value of a respective variable of a color difference, sparkle difference or graininess difference,
Sₓ is the respective angle-specific tolerance or acceptance limit,
x is L or a or b or C or h.

The respective angle-specific tolerance or acceptance limit may be obtained from the following formulae:

$${S}_{L} = {S}_{a} = {S}_{b} = \frac{1}{3}$$

$${S}_{C} = ( 1 + 0.048 * {C}_{R}^{*} ) / 3$$

$${S}_{h} = ( 1 + 0.014 * {C}_{R}^{*} ) / 3$$

in which

$${C}_{R}^{*} = \sqrt{{( {a}_{R}^{*} )}^{2} + {( {b}_{R}^{*} )}^{2}} ,$$

is the colorfulness, i.e., chroma or saturation, of a color reference R in the L*a*b* color space and is calculated using the equation

$${C}_{R}^{*}$$

the index “R” indicating the color reference R.

The assignment rule for solid-color sample coatings (i.e. sample coatings not comprising any effect pigments) may comprise rules which specify that a characteristic value being a maximum value of color differences in the CIEL*C*h* color space between the solid-color sample coating and the solid-color target coating, each measured under different illuminants for a particular measurement geometry (such as) 45°, is assigned
to a scale value 1, when the characteristic value is greater than or equal to 6,
to a scale value 2 when the characteristic value is less than 6,
to a scale value 3 when the characteristic value is less than 4.5,
to a scale value 4 when the characteristic value is less than 3,
to a scale value 5 when the characteristic value is less than 2,
to a scale value 6 when the characteristic value is less than 1.7,
to a scale value 7 when the characteristic value is less than 1.4, or
to a scale value 8 when the characteristic value is less than 1.0.

The assignment rule for effect sample coatings (i.e. sample coatings comprising effect pigments) may comprise rules which specify that assignment
to a scale value 1 is made when a first effect characteristic value, formed on a basis of a sum of all the color differences between the effect sample coating and the effect target coating for a number of measurement geometries between 25° and 75°, is greater than or equal to 12 and each color difference between the effect sample coating and the effect target coating determined at each measurement geometry of 25°, 45°, and 75° is greater than or equal to 6,
to a scale value 2 is made when the first effect characteristic value is less than 12 and each of the color differences determined for the measurement geometries of 25°, 45°, and 75° is less than 6,
to a scale value 3 is made when the first effect characteristic value is less than 10 and each of the color differences determined for the measurement geometries of 25°, 45°, and 75° is less than 4.5,
to a scale value 4 is made when the first effect characteristic value is less than 6 and each of the color differences determined for the measurement geometries of 25°, 45°, 75° is less than 3,
to a scale value 5 is made when the first effect characteristic value is less than 3.9 and each of the color differences determined for the measurement geometries of 25°, 45°, 75° is less than 2,
to a scale value 6 is made when a second effect characteristic value, formed on a basis of a sum of all the color differences between the effect sample coating and the effect target coating for a number of measurement geometries between 15° and 110°, is less than 6.5 and each of the color differences determined for the measurement geometries of 15°, 25°, 45°, 75°, and 110° is less than 2,
to a scale value 7 is made when the second effect characteristic value is less than 6.5, each of the color differences determined for the measurement geometries of 15°, 25°, 45°, 75°, and 110° is less than 1.73, and each sparkle difference between the effect sample coating and the effect target coating, determined for the measurement geometries of 15°, 45°, 75°, is less than 1.73 and a graininess difference between the effect sample coating and the effect target coating is less than 1.73,
to a scale value 8 takes place when the second effect characteristic value is less than 6.5 and each of the color differences formed for the measurement geometries of −15°, 15°, 25°, 45°, 75°, and 110° is less than 1.41, and each sparkle difference determined for the measurement geometries of 15°, 45° and 75° is less than 1.41, and the graininess difference is less than 1.41.

With respect to further details on the aggregating of the determined difference into a single numerical value using the scale described previously, reference is made to US 2017/0328774 A1, the disclosure of which is incorporated by reference.

Comparing the determined differences or single numerical value to the values contained in the provided data associated with the target coating or to threshold value(s) calculated from said provided data can be performed, for example, by retrieving the threshold value(s) contained in the provided data or by calculating threshold value(s), such as color difference values or single numerical values, from the provided data and comparing the determined differences or single numerical values to the retrieved or calculated threshold value(s). In case the determined differences or single numerical value(s) are below the retrieved or determined threshold value(s) associated with the target coating, the randomly generated application parameters are rated as acceptable. Otherwise, the randomly generated application parameters are rated as not acceptable.

Step (iii) may be performed with the computer processor used to perform step (ii) or may be performed with another computer processor. Performing step (iii) with the computer processor performing step (ii) avoids unnecessary data transfer.

In an embodiment, determining optimized application parameters and repeating steps (ii) and (iii) includes:
determining, with the computer processor, optimized application parameters based on the acceptability determined in step (iii) and the provided application parameters using an optimization algorithm, and
repeating steps (ii) and (iii) using the optimized application parameters until the determined optimized application parameters are determined to be acceptable.

Suitable optimization algorithms may include black-box optimization algorithms. Black-box optimization may refer to a problem setup in which an optimization algorithm is supposed to optimize (e.g., minimize) an objective function through a so-called black-box interface. The algorithm may query the value f(x) for a point x, but it does not obtain gradient information, and it cannot make any assumptions on the analytic form of f (e.g., being linear or quadratic), thus the objective function can be considered as being wrapped in a black box. The goal of the optimization is to find an as good as possible value f(x) within a predefined time, often defined by the number of available queries to the black box. Preferred black-box algorithms include Single-Objective evolutionary algorithms (SOEAs) or Many-Objective evolutionary algorithms (MaOEAs), such as, for example, described in Mohammed Mahrach et. al, “Comparison between Single and Multi-Objective Evolutionary Algorithms to Solve the Knapsack Problem and the Travelling Salesman Problem”, Mathematics 2020, 8, 2018 and BINGDONG L I et. al, “Many-Objective Evolutionary Algorithms: A Survey” ACM Computing Surveys, Vol. 48, No. 1, Article 13, 2015.

After the optimized application parameters have been determined, step (ii) is repeated, using the optimized application parameters, i.e. the data associated with the sample coating is determined based on the optimized application parameters, the data associated with the sample coating material and the provided data-driven model(s) as described previously. Afterwards, step (iii) is repeated, i.e. the acceptability of the optimized application parameters is determined based on the data associated with the sample coating determined upon repeating step (ii) and the provided data associated with the reference coating as described previously. In case the optimized application parameters are determined to be acceptable, the inventive method proceeds to step (v), otherwise it repeats steps (ii) and (iii) using the optimized application parameters. Steps (ii) and (iii) may be repeated until the optimized application parameters are determined to be acceptable. The optional step (iv) thus allows to generate application parameters which result in color data fulfilling the threshold value(s) contained in data associated with the reference coating, i.e. in a sample coating having the required optical characteristics (or best matching the characteristics of the reference coating).

Step (iv) may be performed with the computer processor used to perform steps (ii) and (ii) or may be performed with another computer processor. Performing step (iv) with the computer processor performing step (iii) allows to avoid unnecessary data transfer.

Providing the randomly generated application parameters or the optimized application parameters via the communication interface may include providing said application parameters to a display device for display, optionally in combination with further data, on the screen of the display device. The determined parameters may be displayed on the screen of the display device within a GUI. Further data may include data contained in the data associated with the sample coating, the determined data associated with the sample coating, data associated with the coating material application equipment or a combination thereof.

The acceptable randomly generated or optimized application parameters may be interrelated with data associated with the sample coating material and/or the coating material application equipment and may be stored in a database. This allows to quickly retrieve the acceptable randomly generated or optimized application parameters in case they are required again and renders recalculation superfluous.

In an embodiment, the inventive method further includes the following steps:
(vi) in accordance with the determination that the provided or optimized application parameters are acceptable:
   optionally providing via a communication interface to the computer processor a set of defined application parameters,
   comparing with the computer processor the acceptable provided or optimized application parameters to the provided set of defined application parameters and
(vii) in accordance with the determination that the acceptable provided or optimized application parameters match the set of defined application parameters: providing via the communication interface the result of the comparison performed in step (viii), or
(viii) in accordance with the determination that the acceptable provided or optimized application parameters do not match the set of defined application parameters: modifying the formulation of the sample coating material.

In case the provided data associated with the reference coating already contains a set of defined application parameters and the processor performing step (vi) is the same as the processor performing step (i), it is not necessary to provide said application parameters to the processor, because this data was already provided to the processor in step (i).

If the defined set of application parameters is not contained in the provided data associated with the reference coating or the processor performing step (vi) is different from the processor performing step (i), said data has to be provided to the processor via the communication interface. In this case, the set of defined application parameters needs to be retrieved from the provided data associated with the reference coating and provided to the further processor or needs to be retrieved from a data storage medium based on the provided data. For this purpose, the set of defined application parameters may be interrelated with a unique identifier prior to storage. The unique identifier, such as the color name or product code, contained in the data associated with the reference coating, may then be used to retrieve the set of defined application parameters. The set of defined application parameters may comprise specific values for application parameter(s), such as shaping air value(s), flow rate, bell speed, high voltage, distance to object, distance to track and traction speed. The set of defined application parameters may comprise threshold(s) for application parameter(s), such as the aforementioned parameters. The set of defined application parameters may comprise an acceptable numerical range for the application parameter(s).

Comparing the provided set of defined application parameters to the randomly generated or optimized application parameters may be performed by comparing at least part of the application parameter(s) present in the set of defined application parameters to at least part of the randomly generated or optimized application parameter. For instance, each application parameter present in the set of defined application parameters may be compared to each of the randomly generated or optimized application parameters.

Step (vi) may be performed with the computer processor used to perform steps (i) to (v) or may be performed with another computer processor. Step (vi) may be performed with the computer processor performing step (i) to avoid unnecessary data transfer.

If step (vi) is performed, it may be performed prior to step (v) or after step (v).

In case the acceptable randomly generated or optimized application parameters are either below the threshold value(s) or within the acceptable numerical range contained in the provided set of defined application parameters (i.e. the randomly generated or optimized application parameters match the set of defined application parameters), the result of the comparison performed in step (viii) is provided via the communication interface. Providing the result of the comparison may include displaying the set of defined application parameters and the acceptable randomly generated or optimized application parameters. Deviations may be highlighted by coloring or by graphical representations to increase user comfort.

Step (vii) may be performed simultaneously with step (vi) or after step (vi) to ensure that the acceptable provided or optimized application parameters are displayed to the user simultaneously or prior to displaying the result of the comparison. This increases user comfort because it avoids displaying the result of the comparison prior to displaying the determined application parameters used for the comparison.

In case the acceptable randomly generated or optimized application parameters are either above the threshold value(s) or outside the acceptable numerical range contained in the provided set of defined application parameters (i.e. the randomly generated or optimized application parameters do not match the set of defined application parameters), the formulation of the sample coating material may be modified.

Modifying the formulation of the sample coating may include calculating a modified formulation of the sample coating material based on the provided data associated with the sample coating material and the determined su data associated with the sample coating using the method described in European patent application number EP 20213635.4. Briefly, this method includes
optionally retrieving with the computer processor via the communication interface from a database specific optical data of individual color components associated with the formulation of the coating material contained in the provided data associated with the sample coating material,
providing via the communication interface to the computer processor a numerical method and a physical model, wherein the numerical method is configured to optimize application adaption parameters by minimizing a given cost function starting from a given set of initial application adaption parameters, the given cost function being particularly chosen as a color distance between the provided color data of the reference coating and the determined color data of the sample coating, and the physical model is configured to predict the color of the sample coating by using as input parameters the color formulation associated with the sample coating and the retrieved specific optical data of the individual color components and respective preliminary application adaption parameters resulting in the course of optimization, calculating with the computer processor application adaption parameters using the provided numerical method and the physical model by comparing the recursively predicted color of the sample coating with the provided color of the reference coating until the given cost function falls below a given threshold value,
calculating using the provided target color and calculated application adaption parameters as input parameters for the paint color formulation calculation algorithm, a modified sample coating material with optimized concentrations of individual color components as target color formulation for a reference coating material when the reference coating material is applied on a substrate using the provided acceptable application parameters and providing the modified formulation of the sample coating material via a communication interface.

This method may either be performed by the computer processor which is used to perform step (vi) of the inventive method or with a further computer processor being separate from the processor performing step (vi). In the latter case, the data associated with the sample coating material and the determined data associated with the sample coating needs to be provided via a communication interface to the further computer processor. The further computer processor may be located within a further computing device, such as a local computing device or a computing device located in a cloud environment.

The specific optical data of individual color components may be retrieved with the computer processor from the database based on the provided data associated with the sample coating material. For this purpose, the database may comprise the specific optical data of individual color components interrelated with data, such as the color name, the product code, etc., which is contained in the data associated with the sample coating material. This step is generally optional and is only performed if the specific optical data of individual color components is not already contained in the data associated with the sample coating material. The specific optical data of the individual color components is determined based on known reference paint coatings with known reference color formulations and known measured reference colors, respectively, wherein the reference paint coatings are applied onto a substrate using the defined set of application parameters, respectively.

Each application adaption parameter may be assigned to an adaption measure of a number of different adaption measures, such as layer thickness adaption, adaption of effect flake orientation distribution, adaption of effectivity of solid color components, adaption of effectivity of effect color components or a combination thereof.

The paint color formulation calculation algorithm may be implemented on the computer processor calculating the application adaption parameters or may be implemented on a further computer processor. In case the paint color formulation calculation algorithm is implemented on a further computer processor, the calculated application adaption parameters, the specific optical data of individual color components as well as the reference color are provided via a communication interface to the further computer processor. The paint color formulation calculation algorithm is realized by a numerical method and a physical model. The numerical method is configured to optimize concentrations of individual color components of a preliminary color formulation in relation to the target color by minimizing a given cost function, starting from a given initial color formulation, the given cost function being particularly chosen as a color distance between the received reference color and a predicted color of the sample coating formulation, and the physical model is configured to predict the color of the sample coating formulation by using as input parameters concentrations of the individual color components used in the sample coating formulation, specific optical data of the individual color components used in the sample coating formulation and the calculated application adaption parameters, and wherein the optimized concentrations of the color components are calculated by comparing the recursively predicted color of the sample coating formulation with the reference coating color until the given cost function falls below a given threshold.

Providing the modified formulation of the sample coating material via a communication interface may include displaying the modified color formulation via a graphical user interface. The user may then use the displayed information to prepare a modified sample coating composition based on the displayed information and may apply the modified sample coating composition to the substrate using the defined set of application parameters. The calculated modified formulation of the sample coating material may be interrelated with the defined set of application parameters and may be stored in a database. This allows to quickly retrieve the modified formulation of the sample coating material in case it is required again and renders recalculation superfluous.

Step (viii) thus allows to adapt the formulation of the sample coating material to the defined set of application parameters, i.e. it renders manual adaption of the formulation of the sample coating material to achieve the desired optical result with the defined set of application parameters superfluous. This allows to determine a modified formulation of the sample coating material in case the set of defined application parameters has to be used for the application of the sample coating material but the determined randomly generated or optimized application parameters resulting in the desired optical result do not match with said set of defined application parameters.

In summary, the inventive method allows to determine suitable application parameters for a coating material application equipment quickly and reliably for a specific sample coating material without performing extensive application tests requiring human expertise. In case fixed application parameters are used, the inventive method allows to determine a modified formulation of the coating material which, when applied using the fixed application parameters, fulfils defined specifications, thus rendering any tinting expertise to identify suitable coating material formulations superfluous.

In an embodiment, the system further comprises a display device comprising a screen.

The display device may contain an enclosure further housing the computing nodes used to perform at least part of the steps of the inventive method. The enclosure may be made of plastic, metal, glass, or a combination thereof.

The display device and the computing nodes(s) performing the steps of the inventive method may be configured as separate components. The computing node(s) performing the steps of the inventive method is thus present separately from the display device, for example in a further computing device. The computer processor of the display device and the further computer processor are connected via a communication interface to allow data exchange.

The display device may be a mobile or a stationary display device, preferably a mobile display device. Stationary display devices may include computer monitors, television screens, projectors etc. Mobile display devices may include laptops or handheld devices, such as smartphones and tablets.

The screen of the display device may be constructed according to any emissive or reflective display technology with a suitable resolution and color gamut. Suitable resolutions are, for example, resolutions of 72 dots per inch (dpi) or higher, such as 300 dpi, 600 dpi, 1200 dpi, 2400 dpi, or higher. This guarantees that the generated appearance data can displayed in a high quality. A suitably wide color gamut is that of standard Red Green Blue (sRGB) or greater. In various embodiments, the screen may be chosen with a color gamut similar to the gamut perceptible by human sight. In an aspect, the screen of the display device is constructed according to liquid crystal display (LCD) technology, in particular according to liquid crystal display (LCD) technology further comprising a touch screen panel. The LCD may be backlit by any suitable illumination source. The color gamut of an LCD screen, however, may be widened or otherwise improved by selecting a light emitting diode (LED) backlight or backlights. In another aspect, the screen of the display device is constructed according to emissive polymeric or organic light emitting diode (OLED) technology. In yet another aspect, the screen of the display device may be constructed according to a reflective display technology, such as electronic paper or ink. Known makers of electronic ink/paper displays include E INK and XEROX. Preferably, the screen of the display device also has a suitably wide field of view that allows it to generate an image that does not wash out or change severely as the user views the screen from different angles. Because LCD screens operate by polarizing light, some models exhibit a high degree of viewing angle dependence. Various LCD constructions, however, have comparatively wider fields of view and may be preferable for that reason. For example, LCD screens constructed according to thin film transistor (TFT) technology may have a suitably wide field of view. Also, screens constructed according to electronic paper/ink and OLED technologies may have fields of view wider than many LCD screens and may be selected for this reason.

The display device may comprise an interaction element to facilitate user interaction with the display device. In one example, the interaction element may be a physical interaction element, such as an input device or input/output device, in particular a mouse, a keyboard, a trackball, a touch screen or a combination thereof.

In an embodiment, the system may comprise at least one database comprising the data associated with the reference coating and/or the data associated with the coating material application equipment and/or the data associated with the sample coating material and/or the data-driven model(s). The at least one database may be connected to the computer processor via a communication interface such that the computer processor is able to retrieve the data stored in the database as described in relation to the inventive method.

In an embodiment, the system may further comprise at least one coating material application equipment and/or at least one measurement device for determining at least data associated with a coating. Suitable coating material application equipment may include the coating material application equipment described in relation to the inventive method. The coating material application equipment may acquire data, such as target and actual application parameters, during application of the sample coating material and the acquired data may be stored in a database. The acquired data may be correlated with color data of the resulting coating determined with the measuring device and further information on the sample coating material and may be used to generate sets of training data to train the at least one data-driven model. Suitable measurement devices may include spectrophotometers, such as a multi-angle spectrophotometer previously described. The reflectance data and texture images and/or texture characteristics determined with such spectrophotometers at a plurality of measurement geometries may be provided to the computer processor as part of the data associated with the reference coating or may be stored in a database as data associated with a respective sample coating. The spectrophotometer may be used to control whether the application parameters determined with the inventive system indeed result in the desired optical result. The communication interface may be wired or wireless.

The training data set may be provided by collecting data from the application process of a coating material, such as the parameters used during application of the coating material, ranges for said parameters, data being indicative of the equipment used to apply the coating material, surface property data of the resulting coating, for example after curing the applied coating material, and interrelating said data with a coating material identifier, such as the color name, product code, a numerical value, etc., Moreover, the data set may comprise physical properties of the coating material obtained after production of the coating material. The training data sets may be generated during application of coating material onto a substrate and quality control of the resulting coating, for example during production of coated substrates, such as automotive or parts thereof. After compiling said data into a training data set, said set may be stored in a database and may be retrieved by the processor upon initiation of the training.

The training data may be generated by determining suitable application parameters for a given sample coating material. Application parameters may be selected such that a maximum coverage of the parameter space is achieved by preparing as few samples as possible. Suitable application parameters may be determined using latin hypercupe sampling (LHS). The application parameters generated by LHS may then be used to prepare sample coatings for a given sample coating material and the color data as well as the further data may be determined. The application parameters, the determined color data, the coating material formulation, the physical properties of the coating material and optionally the determined film thickness may be used as training data for the data driven model(s).

In an embodiment of a method for training at least one data-driven model for determining application parameters, the property data of coatings includes color data, such as CIEL*a*b* values and/or CIEL*C*h* values, and/or the film thickness of the coating. Said color data may be obtained using a spectrophotometer as previously described after curing the coating obtained after applying the coating material(s) with a coating material application equipment onto a substrate.

In an embodiment of a method for training at least one data-driven model for determining application parameters, a plurality of training data sets is provided. Each training data set is based on sets of data comprising application parameters, CIEL*a*b* and/or CIEL*C*h* values determined at a particular measurement geometry using a particular illuminant and optionally data on the physical properties of the coating material used to prepare the sample coatings. The application parameters may include a specific value for each parameter as well as numerical ranges for said specific parameters. Such data sets may be generated by splitting the obtained color data into the respective measurement geometries and illuminants used to determine said data and generating a training set containing color data determined at exactly one measurement geometry using exactly one illuminant.

In case a plurality of training data sets containing only color data of exactly one measurement geometry is provided, a plurality of data-driven models may be provided, and each provided data-driven model may be trained with exactly one training data set. This allows to increase the accuracy of the determination of the data associated with the sample coating using said plurality of data-driven models, because each model can be optimized with respect to the prediction of color values for a defined measurement geometry.

Trained data-driven model(s) may be retrained with new training data sets, containing training data associated with a new sample coating material (i.e. a sample coating material not yet contained in any data training set). For instance, a new training data set may be generated for a new sample coating material as described previously and said new training data set may be combined with existing training data sets. The trained data-driven model(s) may then be trained (e.g. retrained) with this resulting combined training data set. This allows to improve accuracy of the determined application parameters for a new sample coating material because the data-driven model has already been pretrained with a training data set containing training data for said new sample coating material.

### BRIEF DESCRIPTION OF THE DRAWINGS

These and other features of the present invention are more fully set forth in the following description of exemplary embodiments of the invention. To easily identify the discussion of any particular element or act, the most significant digit or digits in a reference number refer to the figure number in which that element is first introduced. The description is presented with reference to the accompanying drawings in which:

FIG. 1 illustrates a block diagram of a first example of the inventive computer-implemented method for determining application parameters for applying a sample coating material to at least part of a surface of an object such that the resulting sample coating matches the properties of a reference coating;

FIG. 2 illustrates an example of block 116 of FIG. 1;

FIG. 3 illustrates a block diagram of a second example of the inventive computer-implemented method for determining application parameters for applying a sample coating material to at least part of a surface of an object such that the resulting sample coating matches the properties of a reference coating;

FIG. 4 illustrates is a block diagram of an example method for training a data-driven model for determining application parameters for applying a sample coating material to at least part of a surface of an object such that the resulting sample coating matches the properties of a reference coating;

FIG. 5A illustrates an example method of retraining data-driven models provided by the inventive training method;

FIG. 5B illustrates an example of generating a new training data set for a new sample coating material;

FIG. 6 illustrates an example system for determining application parameters for applying a sample coating material to at least part of a surface of an object such that the resulting sample coating matches the properties of a reference coating in accordance with the invention;

FIG. 7 illustrates an example client server setup for the inventive computer-implemented method for determining application parameters for applying a sample coating material to at least part of a surface of an object such that the resulting sample coating matches the properties of a reference coating;

FIG. 8A illustrates an example of a planar view of an input screen populated with an adjustment tool and fields to enter data necessary to determine the application parameters according to the methods disclosed herein;

FIG. 8B illustrates an example of a planar view of an output screen populated with adjustment tools, input data and application parameters determined according to methods disclosed herein.

### DETAILED DESCRIPTION

The detailed description set forth below is intended as a description of various aspects of the subject-matter and is not intended to represent the only configurations in which the subject-matter may be practiced. The appended drawings are incorporated herein and constitute a part of the detailed description. The detailed description includes specific details for the purpose of providing a thorough understanding of the subject-matter. However, it will be apparent to those skilled in the art that the subject-matter may be practiced without these specific details.

In one case, the illustrated separation of various parts in the figures into distinct units may reflect the use of corresponding distinct physical and tangible parts in an actual implementation. Alternatively, or in addition, any single part illustrated in the figures may be implemented by plural actual physical parts. Alternatively, or in addition, the depiction of any two or more separate parts in the figures may reflect different functions performed by a single actual physical part.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). In one implementation, the blocks shown in the flowcharts that pertain to processing-related functions can be implemented by one or more hardware processors.

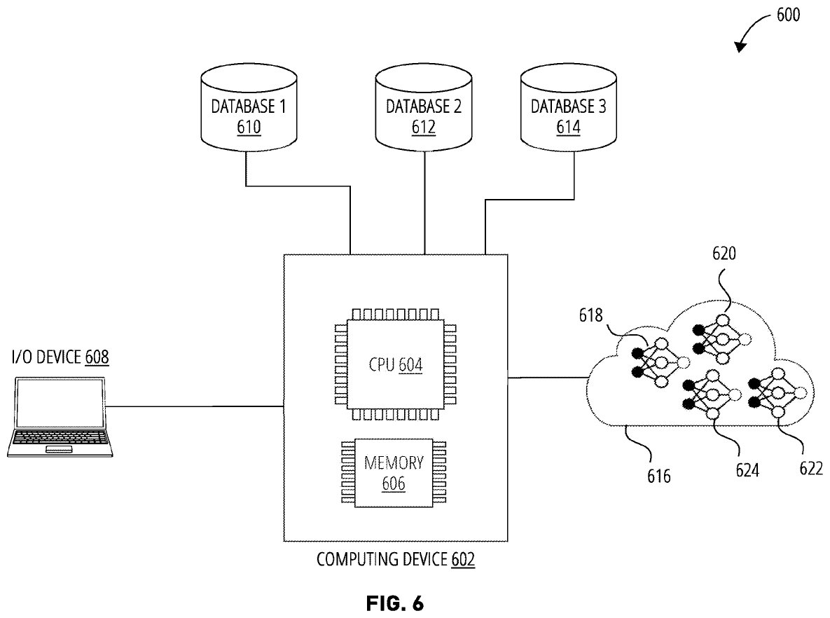

As to terminology, the phrase “configured to” encompasses various physical and tangible mechanisms for performing an identified operation. The mechanisms can be configured to perform an operation using the hardware logic circuitry described in relation to FIG. 6. The term “logic” likewise encompasses various physical and tangible mechanisms for performing a task. For instance, each processing-related operation illustrated in the flowcharts corresponds to a logic component for performing that operation. A logic component can perform its operation using the hardware logic circuitry as described in relation to FIG. 6. When implemented by computing equipment, a logic component represents an electrical component that is a physical part of the computing system, in whatever manner implemented.

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Finally, the terms “exemplary” or “illustrative” refer to one implementation among potentially many implementations.

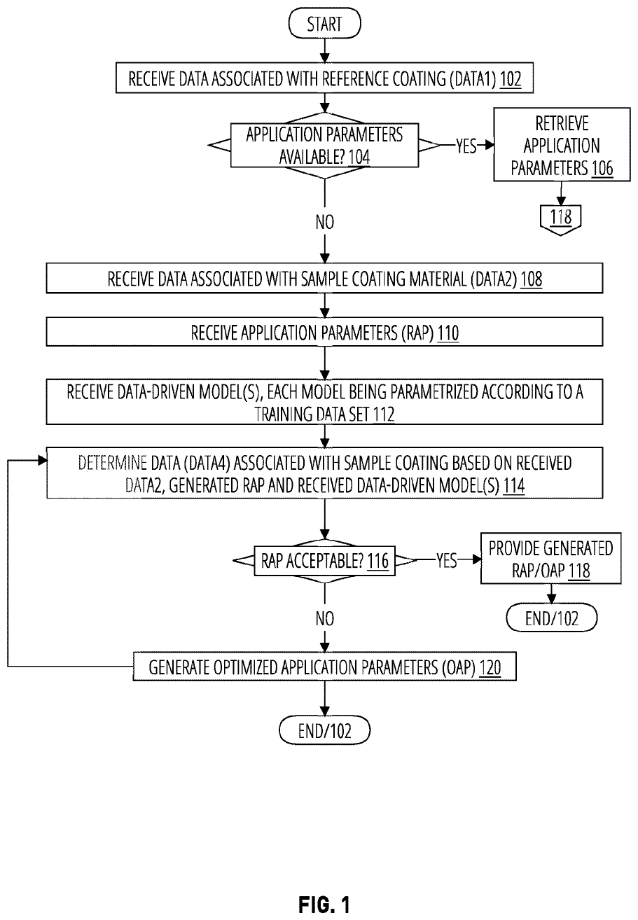

FIG. 1 depicts a first non-limiting example of a method for determining application parameters for applying a sample coating material to at least part of a surface of an object such that the resulting sample coating matches the properties of a reference coating according to the present disclosure. The sample coating material may a liquid basecoat material comprising at least one color and/or effect pigment. The sample coating material may be a liquid clearoat material. The sample coating material may be a liquid primer coating material. The coating material application equipment used to apply the sample coating material to at least part of the surface of an object may be a high-rotational atomization application equipment, such as a high-rotational atomization equipment with electrostatic support. The coating material application equipment may be a pneumatic application equipment. The determined application parameters may be displayed on the screen of a display device, such as a mobile display device having a screen or a stationary device having a screen. The processor used to determine the application parameters may be present separately from the display device, for example on a cloud computing device or a further mobile or stationary computing device being coupled to the display device via a wireless communication interface as depicted in FIG. 6. The processor used to determine the application parameters may be present within the display device.

In block 102, the processor implementing the method may receive data associated with the reference coating (called data1 hereinafter) via a communication interface. Data1 may contain CIEL*a*b* values and CIEL*C*h* values of the reference coating obtained at measurement geometries of −15°, 15°, 25°, 45°, 75° and 110° using at least one illuminant. Data1 may contain the product code(s) of the reference coating material used to prepare the reference coating. Data1 may contain the color difference values (i.e. ΔE_{Lab} and ΔE_{LCh}) for each measurement geometry. Data1 may contain a defined set of application parameters, said set containing either specific values or a range of acceptable values of application parameters. Data1 may contain any combination of the previously mentioned data.

Data1 may be retrieved from a database based on a reference coating identifier. The reference coating identifier may be the product code of the reference coating material used to prepare the reference coating. The reference coating identifier may be provided by a user via the GUI displayed on the screen of the display device. At least part of the retrieved data1, such as the color data, may be displayed on the screen of the display device. Displayed or retrieved data1 may be modified by a user. In case no modification of the displayed data is detected, the retrieved data may be provided to the processor. Otherwise, the data modified by a user may be provided to the processor.

In block 104, the processor may determine whether application parameters are already existing. For instance, application parameters may have been previously determined by the methods disclosed therein and may have been stored on a data storage medium. For this purpose, the routine may access a data storage medium, such as a database, and may search for application parameters interrelated with data contained in data1 provided in block 102, such as, for example, the color name, product code, etc. If the routine identifies application parameters on the data storage medium based on the provided data1, the routine proceeds to block 106. Otherwise the routine proceeds to block 108 described later on.

In block 106, the processor may retrieve the application parameters from the data storage medium based on the provided data1. The retrieved parameters may be displayed on the screen of a display device as described later on, for example as described in relation to block 122. Blocks 104 and 106 may also be performed after block 108. In this case, the application parameters may be retrieved based on the provided data1 and/or the provided data2.

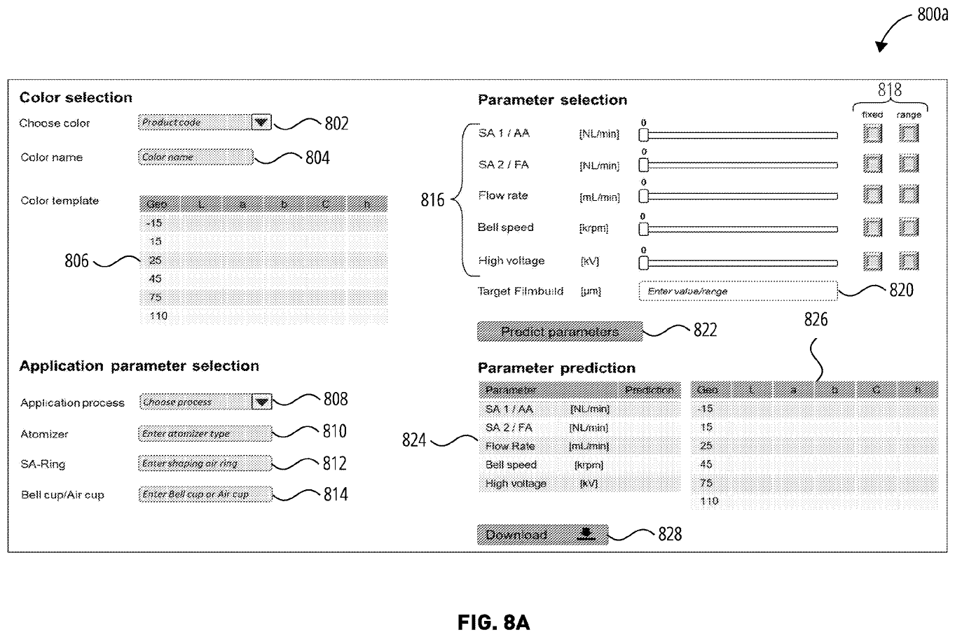

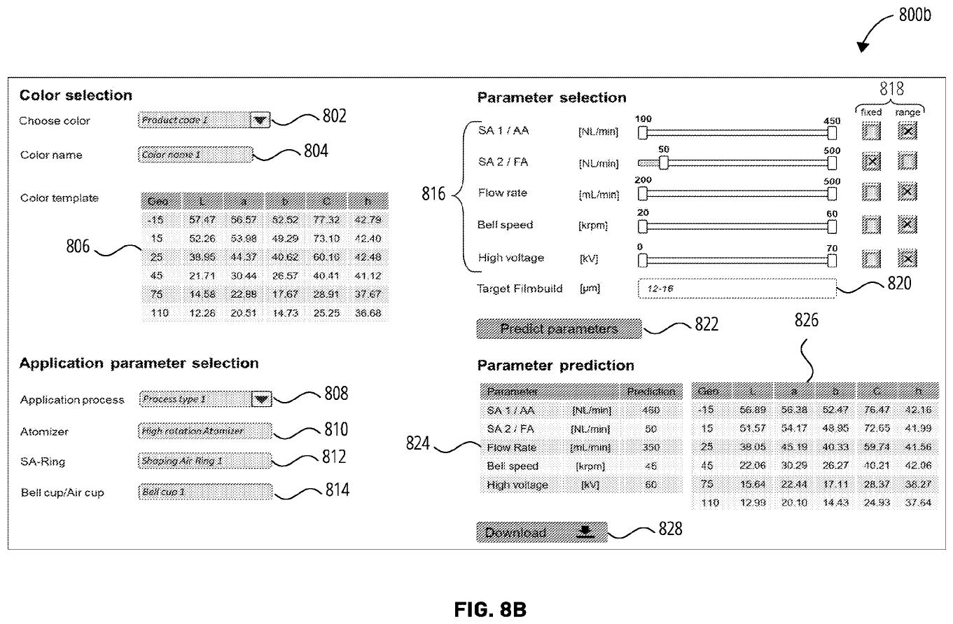

In block 108, the processor may receive the data associated with the sample coating material (called data2 hereinafter) via a communication interface. Data2 may contain a number being indicative of the sample coating material. Data2 may contain the film thickness of the sample coating. The number being indicative of the sample coating material may be retrieved based on the product code entered by a user in block 102. The film thickness of the sample coating may be entered by a user via the GUI displayed on the screen of the display device, for example as described in relation to FIG. 8A. The film thickness may be retrieved by the processor from a database based on the product code entered by a user in block 102.

In block 110, the processor may receive application parameters (denoted RAP hereinafter) via a communication interface. The application parameters may be generated using data associated with a coating material application equipment (denoted as data 3 hereinafter). Data3 may contain a range or a specific value for at least one parameter selected from shaping air value(s), flow rate, bell speed, high voltage, distance to object, distance to track and traction speed. The range for the at least one parameter may be based on technical limitations of said coating material application equipment and/or parameters commonly used for said coating material application equipment. Data3 may be retrieving from a database based on a coating material application equipment identifier(s). The coating material application equipment identifiers may include the application process, the atomizer type, the shaping air ring type and the bell cup or air cap type. The coating material application equipment identifier may correspond to the application process. The coating material application equipment identifiers may be provided by a user via the GUI displayed on the screen of the display device, for example as described in relation to FIG. 8A. The retrieved data, such as the ranges for parameters mentioned above, may be displayed on the screen of the display device and detecting any modifications of the displayed data by the user. The ranges contained in retrieved data3 may be modified using an adjustment tool displayed on the GUI and comprising a plurality of regulators (for example the adjustment tool described in relation with FIG. 8A) by moving the respective regulators via an interaction element. Specific values may be selected by moving the regulator to the desired position and marking a checkbox indicating that the specific value indicated by the position of the regulator is to be used instead of a range indicated by the position of two regulators. Data3 may contain application parameters included in the training data sets used to train the data-driven model(s) provided in block 114 as described later on. The order of blocks 102, 108 and 110 can be reversed or blocks 102, 108 and 110 can be performed simultaneously, as described previously.

Generation of the application parameters based on data associated with a coating material application equipment, such as ranges or specific values for at least one parameter selected from shaping air value(s), flow rate, bell speed and high voltage, may be performed using uniform sampling methods. Uniform sampling may include sampling from a uniform distribution with individual value ranges.

In block 112, the processor may receive at least one data-driven model, each model being parametrized according to a training data set. The training dataset may be based on sets of training data comprising application parameters, data associated with coatings and optionally data associated with the coating material used to prepare the coatings. The training data set may include parameters necessary to apply the coating material to a substrate using a defined coating material application equipment and a range for each parameter necessary to apply the coating material to the substrate using the defined coating material application equipment. The training data set may further include data being indicative of the coating material application equipment, such as the type/model of the atomizer, the type/model of the shaping air ring and the type/model of the bell cup or air cap, and/or data on the application process, such as the type of application process.

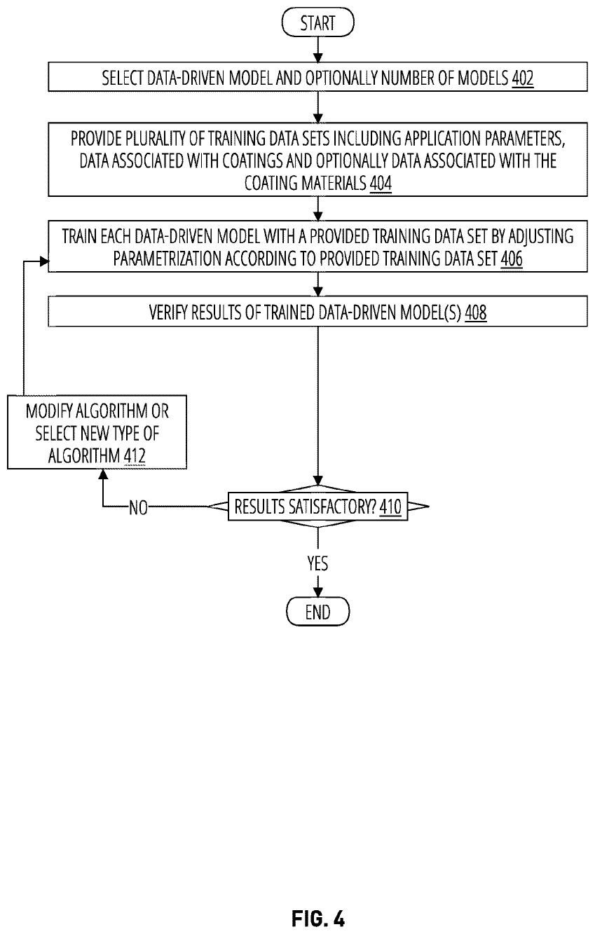

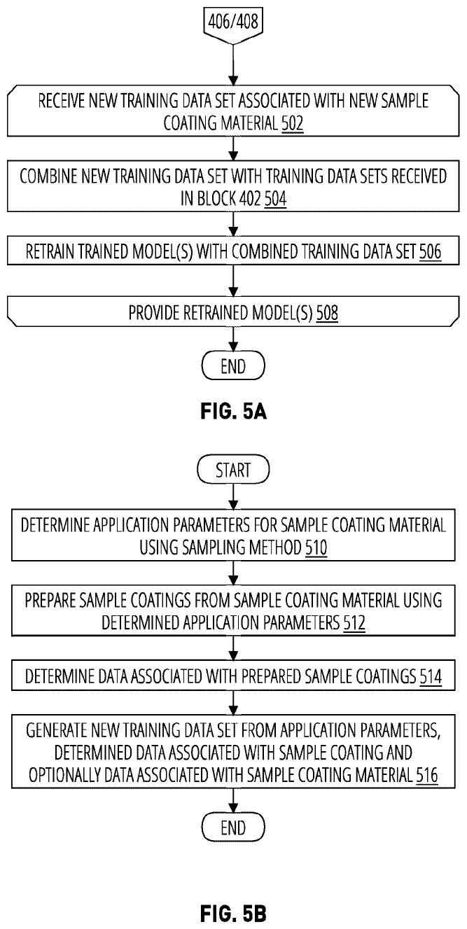

A plurality of data-driven models may be provided in block 112, each data-driven model being parametrized on sets of training data comprising application parameters, selected data associated with coatings and optionally data associated with the coating material used to prepare the coatings. The selected data associated with the coatings may include color data, such as CIEL*a*b* and/or CIEL*C*h* values, determined at a defined measurement geometry using a defined illuminant. The defined measurement geometry may correspond to exactly one aspecular angle contained in the data associated with the reference coating (i.e. data1 provided in block 102). For instance, the number of data-driven models provided in block 114 may equal the number of measurement geometries contained in data1 received in block 102 and each received data-driven model has been trained using color data determined at exactly one measurement geometry contained in data1. If, for example, data1 contains six measurement geometries, such as −15°, 15°, 25°, 45°, 75° and 110°, six data-driven models may be provided, one model being trained on color data obtained at −15°, one model being trained on color data obtained at 15°, one model being trained on color data obtained at 25°, one model being trained on color data obtained at 45°, one model being trained on color data obtained at 75° and one model being trained on color data obtained at 110°. Use of a separate model for each measurement geometry allows a more accurate determination of the data associated with the sample coating in block 114. Training of each data-driven model using the training data sets may be performed as described in relation to FIG. 4. The received trained data-driven model(s) may be retrained data-driven model(s). The trained data-driven models may be retrained as described in relation to FIG. 5A. The training data set(s) used for retraining may be generated as described in relation to FIG. 5B. The plurality of data-driven models may be stored on a remote server, or a cloud server and the respectively trained data-driven models may be retrieved by the routine based on the data contained in provided data1. For instance, the trained data-driven model(s) may be retrieved based on the measurement geometries contained in provided data1. Block 112 may also be performed prior to block 110.

In block 114, the processor may determine the data associated with the sample coating (also denoted as data4 hereinafter) based on data2 received in block 108, application parameters received in block 110 and the data-driven model(s) received in block 112. The data associated with the sample coating may include CIEL*a*b* values and CIEL*C*h* values for each measurement geometry contained in data1 received in block 102. For instance, each data-driven model received in block 112 may determine the CIEL*a*b* and CIEL*C*h* values for the respective measurement geometry it was trained on, such that the color data for all measurement geometries contained in data1 are determined in this block. The data associated with the sample coating may be determined with the computer processor performing blocks 102 to 112. The data associated with the sample coating may be determined with a further computer processor. In the latter case, received data1 and data2 may be provided via a communication interface to the further processor along with the randomly generated application parameters and the further computer processor may receive the data-driven model(s) as described in relation to block 112.

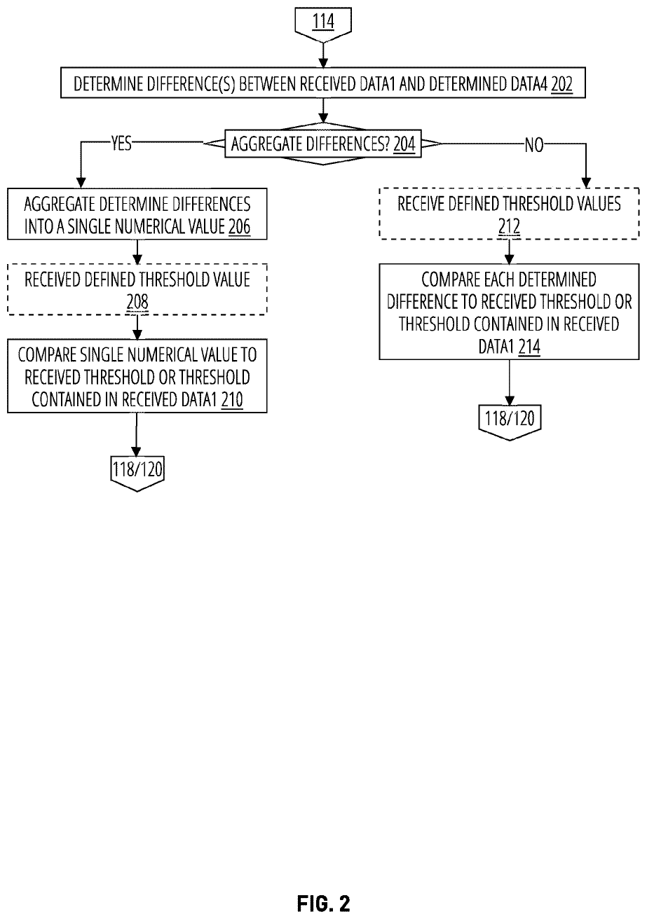

In block 116, the computer processor may determine the acceptability of the application parameters (RAP) provided in block 110. The acceptability of the RAP may be determined as described in relation to FIG. 2. For instance, the processor may determine whether determined data4 is below given threshold values (see also FIG. 2) or not. This ensures that the color of the reference coating and the color resulting from applying a sample coating material to the substrate using the randomly generated application parameters match sufficiently with respect to color and/or texture. If the determined data4 is below given threshold values, the randomly generated application parameters are rated as acceptable and the processor proceeds to block 122. Otherwise, the randomly generated application parameters are rated as not acceptable and the processor proceeds to block 124 described later on.

In block 118, the provided application parameters—or in case block 118 is repeated, the optimized application parameters (OAP)—may be provided via a communication interface. The RAP/OAP may be provided to a display device for display on the screen of said device. Display may be performed within a GUI on the screen of the device. Suitable display devices may include the input/output device 608 described in relation to FIG. 6 later on.

In block 120, the processor may optimize the provided application parameters. Optimizing the application parameters may include determining optimized application parameters (also denoted as OAP) based on the result of blocks 114 and 116 and the provided application parameters using an optimization algorithm. The optimization algorithm may be a black-box optimization algorithm described previously. The optimization algorithm may us a covariance matrix adaptation evolution strategy (CMA-ES). After optimized application parameters are determined, the processor proceeds to block 114 and repeats blocks 114 and 116 described previously. This looping may be performed until the optimized application parameters are determined to be acceptable in block 116. This ensures that the optical result when applying the sample coating material to the substrate using the randomly generated or optimized application parameters fulfils the required quality in terms of color matching, i.e. the color data is within the predefined threshold value(s).

FIG. 2 illustrates an example of block 116 of FIG. 1. In block 202, the processor may determine the difference(s) between data1 received in block 102 and the data determined in block 114 of FIG. 1. Determining the difference(s) between received data1 and determined data4 may include defining color difference values for each CIEL*a*b* and CIEL*C*H* value contained in data1 and determined in block 114 for each measurement geometry. The color difference values for the received and determined CIEL*a*b* values may be obtained using a weighted color tolerance equation, such as previously described. Apart from determining color difference values, sparkle differences and graininess differences may also be determined. This may be performed if the reference coating and the sample coating are effect coatings comprising at least one effect pigment. This allows to more accurately determine whether the optical appearance of the sample coating matches the optical appearance of the reference coating.

In block 204, the processor may determine whether the differences determined in block 202 should be aggregated or not. If the processor determines that the differences should be aggregated, it proceeds to block 206. Otherwise, the processor proceeds to block 212 described later on.

In block 206, the processor may aggregate the differences determined in block 202 into a single numerical value. For instance, the processor may calculate an average difference by summing up all determined differences, such as the color difference values determined in block 202, and dividing the obtained sum by the number of determined difference values. For instance, the processor may calculate a single numerical value by standardizing the determined color differences and/or sparkle differences and graininess differences and assigning a single numerical value to a group of characteristic values calculated from the respective standardized color differences and/or sparkle differences and graininess differences using an assignment rule provided in advance. Standardization may be performed as described previously. Suitable assignment rules for solid-color as well as effect color coatings have been described previously and may be used by the processor to assign a single numerical value to a group of characteristic values calculated from the respective standardized color difference values and/or sparkle and graininess differences.

In block 208, the processor may receive a defined threshold value for the aggregated difference calculated in block 206, this step being generally optional. This step only has to be performed if the defined threshold value is not already contained in the data1 received in block 102 of FIG. 1. Receiving the defined threshold value may include retrieving the defined threshold value from a database based on the received data1.

In block 210, the processor may compare the single numerical value calculated in block 206 to the defined threshold value received in block 206 or the defined threshold value contained in data1 received in block 102 of FIG. 1. The processor may retrieve the defined threshold value contained in data1 and may compare this defined threshold value to the single numerical value calculated in block 206. The processor may calculate a threshold value, such as a single numerical value, from the data, such as color data, contained in received data1 prior to comparing said values. The single numerical value may be calculated by the processor from the data, such as the color data, as described in relation to block 206. The method then proceeds to block 120 described in relation to FIG. 1.

In block 212, the processor may receive defined threshold values for each difference determined in block 202, this step being generally optional. This step only has to be performed if the defined threshold values are not already contained in the data1 received in block 102 of FIG. 1. Providing the defined threshold values may be performed as described in relation to block 208.

In block 214, the processor may compare each difference determined in block 202 to each threshold value contained in data1 received in block 102 or each threshold value received in block 212. The processor may retrieve the defined threshold values contained in data1 and may compare each defined threshold value to each difference determined in block 202. The processor may calculate threshold values, such as color difference values, from the data, such as color data, contained in the received data1 prior to comparing each value. The method then proceeds to block 118 described in relation to FIG. 1.

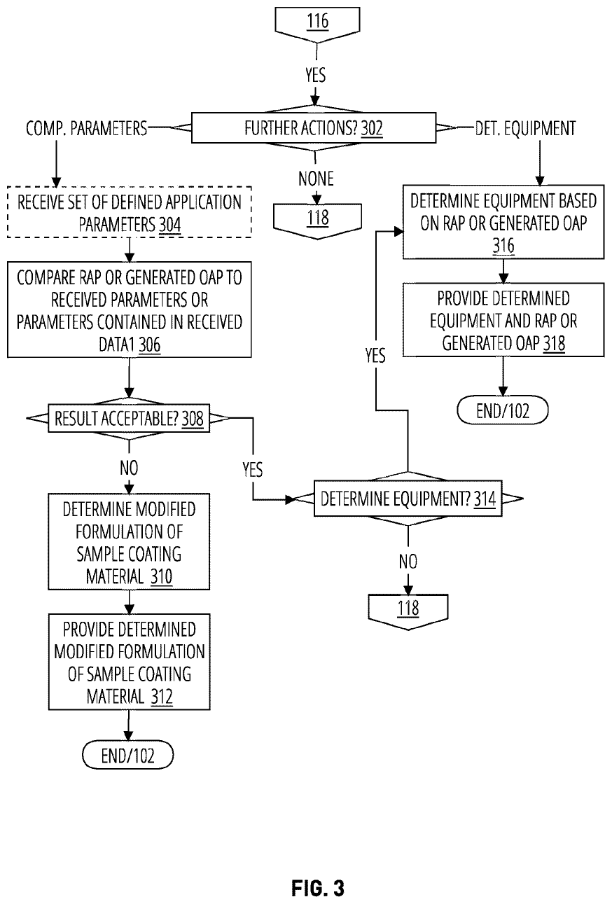

FIG. 3 illustrates a second non-limiting embodiment of a method for determining application parameters for applying a sample coating material to at least part of a surface of an object such that the resulting sample coating matches the properties of a reference coating according to the present disclosure. The sample coating material may a liquid basecoat material comprising at least one color and/or effect pigment. The sample coating material may be a liquid clearoat material. The sample coating material may be a liquid primer coating material. The coating material application equipment used to apply the sample coating material to at least part of the surface of an object may be a high-rotational atomization application equipment, such as a high-rotational atomization equipment with electrostatic support. The coating material application equipment may be a pneumatic application equipment. The determined application parameters may be displayed on the screen of a display device, such as a mobile display device having a screen or a stationary device having a screen. The processor used to determine the application parameters may be present separately from the display device, for example on a cloud computing device or a further mobile or stationary computing device being coupled to the display device via a wireless communication interface as depicted in FIG. 6. The processor used to determine the application parameters may be present within the display device. The method of FIG. 3 may include blocks 102 to 116 described in relation to FIG. 1 or blocks 102 to 120 described in relation to FIG. 1. Apart from said blocks, the method of FIG. 3 may contain additional blocks described in the following. Said additional blocks may be performed if the provided or optimized application parameters are rated acceptable

In block 302, the processor may determine whether further actions are to be performed. This determination may be made in response to detecting a user input and determining whether the user input is indicative of a further action. For example, a GUI may be displayed on the display device connected with the processor and the GUI may comprise a menu allowing a user to select further actions. In response to detecting a user input, the processor may determine the appropriate further action based on the detected user input. The method proceeds to block 304 if the determined application parameters are to be compared to a set of defined application parameters. The method may proceed to block 314 if an application equipment is to be determined. The method may proceed to block 118 of FIG. 1 if no further action is to be performed.

In block 304, the processor may receive a set of defined application parameters, this step being generally optional. This step only has to be performed if the defined set of application parameters is not already contained in the data1 received in block 102 of FIG. 1. The processor may retrieve said parameters based on data contained in data1, such as the color name or product code, from a database containing sets of defined application parameters interrelated with said data. The processor may retrieve said parameters from data1 received in block 102 of FIG. 1.

In block 306, the processor may compare the provided or—if block 120 of FIG. 1 is performed at least once—the optimized application parameters to the set of defined application parameters received in block 102 of FIG. 1 or received in block 304. The received set of defined application parameters may include specific values for each equipment part of the coating material application equipment, such as the atomizer, the shaping air ring, the bell cup and/or air cap. The received set of defined application parameters may include an acceptable range for each equipment part.

In block 308, the processor may determine whether the provided or optimized application parameters match the specific values or lie within the acceptable range included in the received set of defined application parameters. If this is the case, the processor rates the randomly generated or optimized application parameters as acceptable and proceeds to block 314 described later on. If this is not the case, the processor rates the randomly generated or optimized application parameters as not acceptable and proceeds to block 310 described in the following.

In block 310, the processor may determine a modified formulation of the sample coating material. This may include calculating a modified formulation of the sample coating material based on the received data associated with the sample coating material and the determined data associated with the sample coating using the method described in European patent application number EP 20213635.4 as previously described. Block 310 allows to adapt the formulation of the sample coating material to the defined set of application parameters, i.e. it renders manual adaption of the formulation of the sample coating material to achieve the desired optical result with the defined set of application parameters superfluous. This allows to determine a modified formulation of the sample coating material in case the set of defined application parameters has to be used for the application of the sample coating material but the determined randomly generated or optimized application parameters resulting in the desired optical result do not match said set of defined application parameters.

In block 312, the processor may provide the modified formulation of the sample coating material. Providing the modified formulation may include displaying said modified formulation on the screen of a display device. This may include providing said data to the processor of the display device. The modified formulation may be stored on a data storage medium, optionally after interrelating the data with an identifier, for example an identifier being indicative of the reference coating and/or the defined set of application parameters. This allows to retrieve the determined modified sample coating formulation in case it is requested once again and renders recalculation superfluous. The data may be displayed within a GUI, such as for example shown in relation to FIG. 8B. Suitable display devices are the ones described in relation to the input/output device 608 of FIG. 6. Further data, such as the determined application parameters, the result of the comparison to defined set of application parameters, etc. may be displayed along with the modified formulation of the sample coating material. The processor then ends method 200 or returns to block 102 of FIG. 1, for example if a user wants to determine application parameters for a new sample coating material.

In block 314, the processor may determine whether the coating material application equipment is to be determined. The coating material application equipment may be determined if a specific user input is detected in block 314 via a GUI displayed to the user, for example by detecting a defined user interaction, such as a click on a defined button indicating determination of the coating material application equipment. If the coating material application equipment is to be determined, the processor may proceed to block 316, otherwise it proceeds to block 118 FIG. 1.

In block 316, the processor may determine the coating material application equipment based on the provided or—if blocks 114 and 116 of FIG. 1 are repeated at least once —on the optimized application parameters. The coating material application equipment may be determined by comparing the randomly generated or optimized application parameters to application parameters or ranges of suitable application parameters stored in a database and being interrelated with parts of a coating material application equipment, such as the type/model of atomizer, shaping air ring and/or bell/air cap. The coating material application equipment may be determined by determining discriminatory features between parts of the coating material application equipment, such as the atomizer, the shaping air ring and the bell or air cap, are determined using a data-driven model parametrized on sets of application parameters and associated coating material application equipment. These discriminatory features may then be used by the data-driven model to identify a suitable application equipment, in particular a suitable atomizer, shaping air ring and bell or air cap.

In block 318, the processor may provide the determined coating material application equipment and the provided or—if blocks 114 and 116 of FIG. 1 are repeated at least once—the optimized application parameters. Providing the data may include displaying the data. The data may be stored on a data storage medium, optionally after interrelating the data with an identifier, for example an identifier being indicative of the reference coating. This allows to retrieve the determined application parameters and/or coating material application equipment in case they are requested once again and renders recalculation superfluous. The data may be displayed within a GUI, such as for example shown in relation to FIG. 8B. Suitable display devices are the ones described in relation to the input/output device 608 of FIG. 6. Further data used to determine the application parameters and/or the coating material application equipment, threshold value(s) etc., result of comparison to defined set of application parameters may be displayed along with the determined coating material application equipment and the randomly generated or optimized application parameters. The processor then ends the method or returns to block 102 of FIG. 1, for example if a user wants to determine application parameters for a new sample coating material.

FIG. 4 shows an illustrative process to train data-driven models. The data-driven models may be machine learning algorithm(s). The machine learning algorithm(s) may be ensemble learning algorithm(s), such as gradient boosting machines (GBM), gradient boosting regression trees (GBRT), random forests or a combination thereof. In one illustrative embodiment of method, machine learning is used to train the algorithm to determine the application parameters. The data-driven model(s) may use as input the data associated with the sample coating material and the randomly generated application parameters/optimized application parameters to determine and output data associated with the sample coating. Data associated with the sample coating may include color data. The color data may include CIEL*a*b* and/or CIEL*C*H* values.

The data-driven models may be hosted by a computing device, a remote server or a cloud or other server (such as described in relation to FIG. 6). Advantageously, by locating the data-driven model(s) on a remote server or a cloud server, costs of added memory and/or a more complex processor to determine the application parameters can be avoided for each computing device. Additionally, continuous, or periodic improvement of the data-driven model(s) can more easily be done on a centralized server and avoid data costs, and risks of pushing out an update of the data-driven model(s) to each computing device. A remote server may also serve as a central repository storing training data and/or collections of data sent from various computing devices to be used to train and develop existing data-driven model(s). For instance, a growing repository of data may be used to update and improve data-driven model(s) on existing systems and to provide improved data-driven model(s) for future use. An exemplary available software to implement process 500 is scikit-learn (available on the Internet at https://scikit-learn.org), an open-source machine learning library that runs on Windows, macOS and Linux. Another exemplary commercially available software is MATLAB (available on the Internet at mathworks.com) which provides classification ensembles in the Statistics and Machine Learning Toolbox. Examples of available software for ANN models is Keras (available on the Internet at Keras.io), an open-source ANN model library that runs on top of either TensorFlow or Theano, which provide the computational engine required. TENS ORFLOW (an unregistered trademark of Google, of Mountain View, Calif.) is an open-source software library originally developed by Google of Mountain View, Calif, and is available as an internet resource at www.tensorflow.org. Theano is an open software library developed by the Lisa Lab at the University of Montreal, Montreal, Quebec, Canada, and is available as an internet resource at deeplearning.net/software/theano/.

In step 402, the data-driven model(s) may be selected. Optionally, the method can be tailored for a selected number of data-driven model types and/or dimensions to compare the accuracy and select a preferred data-driven model for any particular container or related application. Guidelines known to those skilled in the art and/or associated with specific algorithm software may aid in the initial selection of the model type and dimensions. For instance, a collection of gradient boosting regressor trees may be used as data-driven model. One data-driven model may be used for each measurement geometry contained in the data associated with the reference coating. For instance, six different data-driven models, each one containing a collection of gradient boosting regressor trees, may be used for the six measurement geometries contained in the data associated with the reference coating. All data-driven models may be treated equally. All data-driven models may be weighted differently. The results of all data-driven models may be aggregated. For instance, a single numerical value may be determined as described in relation with FIG. 2. In another instance, aggregation may be performed by a majority decision.

In step 404, a plurality of training data sets may be provided. Said training data sets may be obtained by combining already available data or by generating new training data sets as described in relation to FIG. 5B. Each training data set may contain application parameters, data associated with coatings prepared using said application parameters and optionally data associated with the coating materials used to prepare the coatings. Data associated with coatings may include CIEL*a*b* and/or CIEL*C*H* values, such as CIEL*a*b* and/or CIEL*C*H values determined at a plurality of measurement geometries using at least one illuminant. The training data sets may be divided into three portions: the training set, the validation set, and the verification (or “testing”) set. Gradient tree boosting may be used to update the data-driven model(s) during training. The validation set may be used to minimize overfitting. The validation set typically does not adjust the data-driven model as does the training set, but rather verifies that any increase in accuracy over the training data set yields an increase in accuracy over a data set that has not been applied to the data-driven model(s) previously, or at least the data-driven model(s) has/have not been trained on it yet (i.e. validation data set). If the accuracy over the training data set increases, but the accuracy over the validation data set remains the same or decreases, the process is often referred to be “overfitting” the data-driven model(s) and training should cease. Finally, the verification set is used for testing the trained data-driven model(s) to confirm the actual predictive power of the data-driven model(s).

For instance, approximately 70% of the training data sets may be used for model training, 15% may be used for model validation, and 15% may be used for model verification. These approximate divisions may be altered as necessary to reach the desired result.

For instance, nested cross-validation may be used. Nested cross-validation is an approach to model hyperparameter optimization and model selection such that overfitting of the training data set is avoided. Nested cross-validation involves treating model hyperparameter optimization as part of the model itself and evaluating it within the broader k-fold cross-validation procedure for evaluating models for comparison and selection. As such, the k-fold cross-validation procedure for model hyperparameter optimization is nested inside the k-fold cross-validation procedure for model selection. The k-fold cross-validation procedure divides a limited dataset into k non-overlapping folds. Each of the k folds is given an opportunity to be used as a held back test set whilst all other folds collectively are used as a training dataset. A total of k models are fit and evaluated on the k holdout test sets and the mean performance is reported. Each training dataset is then provided to a hyperparameter optimized procedure, such as grid search or random search, that finds an optimal set of hyperparameters for the model. The evaluation of each set of hyperparameters is performed using k-fold cross-validation that splits up the provided training dataset into k folds. The size of the training data set may be varied. For instance, about 40.000 sets of data may be collected, each set including application parameters, data associated with the coatings prepared using the application parameters, and optionally data associated with the coating materials used to prepare the coatings. The data associated with the coatings may include color data, such as CIEL*a*b* and CIEL*C*H* values obtained at a plurality of measurement geometries using at least one illuminant. The training data set may include samples throughout a full range of existing coating materials and corresponding coating layers.

In Step 406, the data-driven model(s) may be pointed to the training and validation portions of the training data set. Training is an iterative process that adjusts the parametrization of the data-driven model(s) according to the data contained in the training data set. With each iteration of training data to adjust the parametrization, the validation data is run on the models and one or more measures of accuracy is determined by comparison of the model output of application parameters with the actual application parameters collected with the training data. For example, generally the standard deviation and mean error of the output will improve for the validation data with each iteration and then the standard deviation and mean error will start to increase with subsequent iterations. The iteration for which the standard deviation and mean error is minimized is the most accurate set of weights for that model for that training set of data. In case of an ensemble learning algorithm, training may be performed by modifying the parameters of each data-driven model using bagging or boosting as previously described or by modifying the weighting of each classifier/regressor.

In Step 408, the data-driven model(s) may be pointed to the verification data set and a determination of whether the output of the data-driven model(s) is sufficiently accurate when compared to the actual application parameters measured with collection of the data. If the accuracy is not sufficient, the method proceeds to step 412. In step 412, the data-driven model(s) is/are modified using the current training data set to improve the accuracy or data-driven model(s) of a different type and/or dimension are selected.

Once the data-driven model(s) has/have been selected and trained to sufficient accuracy, the method ends and the data-driven model(s) are implemented, for example as described in relation to FIGS. 1 to 3 above. For example, in an illustrative embodiment, the trained data-driven model(s) are hosted in software form by a remote server. Alternatively, the data-driven model(s) could be hosted in hardware form and/or could be hosted by the computing device described in relation to FIG. 6, optionally with a wireless data connection to the remote server to receive updates or modifications to the locally-hosted data-driven model(s) if necessary.

The data-driven model(s) may be improved over time with additional data (e.g. may be retrained), for example as described in relation to FIGS. 5A and 5B. For example, operational data (e.g., collections of application parameters, data associated with coatings and optionally data associated respective coating materials) may be collected upon applying coating material to a substrate and may be used to further train and improve the data-driven model(s), essentially growing the aggregate training data set over time. This operational data may be compiled from a number of sources, including painting lines.

One illustrative method of gathering this operational data is from customers who apply coating material using coating material application equipment on substrates. Once the coating material is applied to the surface, cured and afterwards analyzed, an accurate set of data can be obtained, and the collected data can be analyzed to confirm the data-driven model(s) output readings. After repeating this process through multiple applications of the coating material, the algorithms will collect enough verified data to be used to further train the data-driven model(s) to improve the accuracy of the determination.

FIG. 5A illustrates an example method of retraining trained data-driven models. The trained data-driven models may be provided, for example, by the method described in relation to FIG. 4. Retraining may include training the already trained data-driven models with a training data set comprising additional training data.

In block 502, a new training data set may be received by the processor implementing the retraining method. Said new training data set may be obtained, for example, as described in relation to FIG. 5B. The new training data set may be stored in a database and may be retrieved by the processor upon initiating the retraining method.

In block 504, the processor may combine the received new training data set with training data sets received in block 402 of FIG. 4, i.e. with training data sets used to provide the trained data-driven models (existing training data sets). Combining the data sets may include retrieving the data sets used in block 402 and combining the retrieved data with the received new data. The weighting of the new training data in comparison to the existing training sets may be determined using heuristic methods.

In block 506, the processor retrains the trained data-driven model(s) with the combined training data set. For example, the trained data-driven model(s) resulting from the method described in relation to FIG. 4 are retrieved by the processor and are retrained using the steps described in relation with blocks 406 to 412 of FIG. 4.

In block 508, the processor may provide the retrained data-driven model(s), for example as described in relation to FIG. 4. Retraining already trained data-driven models allows to improve the accuracy of the determination, especially for sample coating materials which are associated with data not contained in the training data sets used to train the data-driven model(s). Retraining may only require the preparation of a small number of sample coatings to significantly improve the accuracy of the determination compared to using trained data-driven model(s) not having been trained with said data.

FIG. 5B illustrates an example method for generating a new training data set. The new training data set may be generated for a new sample coating material for which data is not yet contained in the training data set(s) used to train the data-driven models (for example as described in relation to FIG. 4). The new training data set may be used to retrain already trained data-driven models to improve the accuracy of the determination as described in relation to FIG. 5B.

In block 510, application parameters for a sample coating material may be determined using sampling method(s). The sample coating material may be a new sample coating material as previously described. The application parameters should cover as many different application parameter values as possible. This may be achieved by sampling methods, such as latin hypercube sampling (LHS). LHS tries to achieve a maximum coverage of the parameter space with as few samples as possible, thus reducing the effort necessary to prepare the sample coatings from the sample coating material and to acquire the relevant data from the sample coatings.

In block 512, sample coatings may be prepared from the sample coating material using the application parameters determined in block 510. For instance, the sample coatings may be prepared by applying the sample coating material to the surface of a substrate with a coating material application equipment, such as an optionally coated metal panel, using the determined application parameters. The applied sample coating material may be dried and/or cured to form the respective sample coating. Further coating materials may be applied prior to the respective sample coating material or after the respective sample coating material to form the sample coating.

In block 514, data associated with the sample coatings prepared in block 512 may be determined. The data may be determined by acquiring said data using a measurement device. The measurement device may include a multi-angle spectrophotometer. The acquired data may include color data, such as CIEL*a*b* and CIEL*C*H* data and/or texture characteristics. The data may be acquired at one or more measurement geometries using one or more illuminants. The acquired data, such as reflectance data and/or texture images, may be processed by the measurement device or a further computing device to obtain the color data.

In block 516, the new training data set may be generated. The new training data set includes the application parameters determined in block 510 as well as the corresponding data associated with the sample coating prepared from the sample coating material using the respective determined application parameters. The training data set may also include data associated with the sample coating material as described previously (for example as described in relation to block 108 of FIG. 1).

FIG. 6 shows an example of a system 600 for determining application parameters for applying a sample coating material to at least part of a surface of an object such that the resulting sample coating matches the properties of a reference coating in accordance with the present disclosure. System 600 may be used to implement the method described in relation to FIGS. 1 to 3. System 600 may comprise a computing device 602 housing computer processor 604 and memory 606. The processor 604 may be configured to execute instructions, for example retrieved from memory 606, and to carry out operations associated with the computer system 600. The operations may include the steps described in relation with FIGS. 1 to 3.

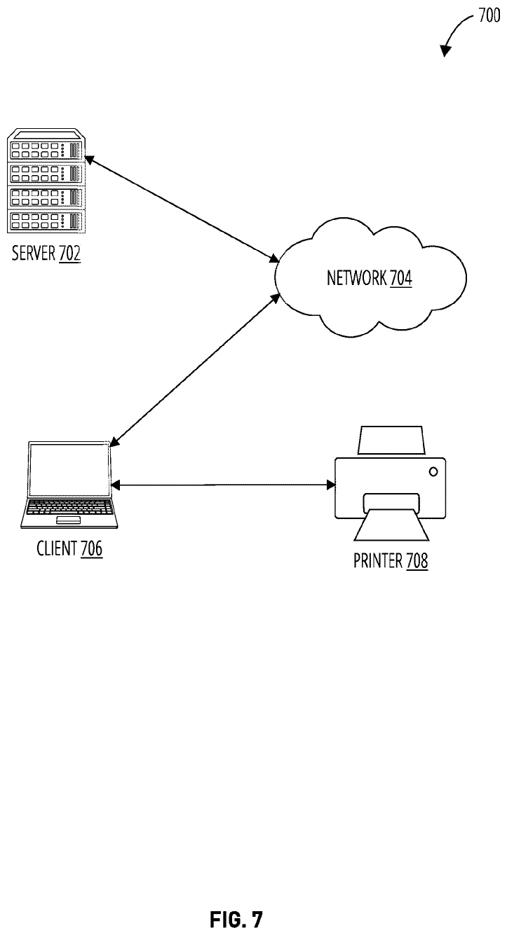

The processor 604 may be a single-chip processor or may be implemented with multiple components. In most cases, the processor 604 together with an operating system operates to execute computer code and to produce and use data. The computer code and data may reside within memory 606 that is operatively coupled to the processor 604. Memory 606 generally provides a place to hold data that is being used by system 600. By way of example, memory 606 may include Read-Only Memory (ROM), Random-Access Memory (RAM), hard disk drive and/or the like. In another example, computer code and data could also reside on a removable storage medium and loaded or installed onto the computer system when needed. Removable storage mediums include, for example, CD-ROM, PC-CARD, floppy disk, magnetic tape, and a network component. The processor 604 can be located on a local computing device or in a cloud environment (see for example FIG. 7). In the latter case, input/output device 608 may serve as a client device and may access the server (i.e. computing device 602) via a network.

System 600 may further include an input/output device 608 which is coupled via a communication interface to computing device 602. Input/output device 608 may receive the determined application parameters from processor 604 and may display the received data on the screen, for example via a graphical user interface (GUI), to a user (see for example FIG. 8B). The input/output device 608 may comprise a screen and is integrated with a processor and memory (not shown) to form a desktop computer (all in one machine), a laptop, a handheld, a tablet or a smartphone. The input/output device 608 may be used to detect user input. The detected user input may be used to retrieve the data stored in databases 610, 612, 614. The screen the input/output device 608 may be a separate component (peripheral device, not shown). By way of example, the screen of the input/output device 608 may be a monochrome display, color graphics adapter (CGA) display, enhanced graphics adapter (EGA) display, variable-graphics-array (VGA) display, super VGA display, liquid crystal display (e.g., active matrix, passive matrix and the like), cathode ray tube (CRT), plasma displays and the like.

The computing device 604 may be connected via communication interfaces to databases 610, 612, 614. The number of databases may vary and may be more or less. For instance, data1, data2 and data3 mentioned in relation with FIG. 1 may be stored in one database or in separate databases. Database 610 may store data associated with the reference coatings (e.g. data1), database 612 may store data associated with the coating material application equipments (e.g. data2) and database 614 may store the data associated with the sample coating materials (e.g. data3). The data stored in said databases may be retrieved by processor 604 via the communication interfaces. Data associated with the reference coatings stored database 610 may contain color data, such as CIEL*a*b* and CIEL*C*H* values. The color data may be determined at a plurality of measurement geometries using at least one illuminant. The data may contain threshold value(s) for said color values. Data associated with the reference coating may include further data as previously described. Data associated with the sample coating material stored database 614 may contain the target film thickness, i.e. the film thickness of the sample coating layer resulting from applying a sample coating material with a coating material application equipment onto the surface of the object. Data associated with the sample coating material may include a numerical value assigned to the sample coating material. Data associated with the sample coating material may include data related to the properties of the sample coating material, such as data related to the chemical and/or physical properties. Data associated with the sample coating material may include further data as previously described. The respective data may be retrieved from database 610, 612, 614 by processor 604 based on data inputted by a user via input/output device 608. The respective data may be retrieved from database 610, 612, 614 by processor 604 based on data associated with a predefined user action performed on the input/output device 608, for example by selecting a desired action (e.g. display of a list of available sample coating materials, display of a list of available coating material application equipment's or parameters thereof, etc.) on a GUI of input/output device 608.

The data-driven model(s) may be stored in one or more databases (not shown). The data-driven model(s) may be stored in memory 606 of computing device 602 (not shown). The data-driven model(s) may be stored in a cloud, such as cloud 616 in which data driven-model(s) are stored. The cloud 616 may include one or more servers, for example the computing device 602 described in relation to FIG. 6. A plurality of data-driven models 618 to 624 may be stored in cloud 616. The number of data-driven models may vary and may be more or less than shown in FIG. 6. The number of data-driven models may depend, for example, on the number of measurement geometries used to determine the data associated with the reference coating. The data-driven models may have been trained in accordance with the method described in relation to FIGS. 4, 5A and 5B below. Each data-driven model 618 to 624 may have been trained on training data sets containing the training data mentioned in relation to FIGS. 4, 5A and 5B. Each data driven model may be trained with training data sets containing color data acquired at a specific measurement geometry as previously described. The cloud 616 may contain a service layer (not shown) containing one or more databases to store training data sets acquired during preparation of coatings as described in relation with FIGS. 4, 5A and 5B. The cloud 616 may provide a functionality to train the data-driven models 618 to 624 with the training data sets acquired as previously described. Processing device 602 may be coupled via a gateway to the cloud 616 (not shown). Processing device 602 may be coupled directly to the cloud 616. In this case, processing device 502 may be configured with any of the gateway functionality and components described herein and treated like a gateway by cloud 616, at least in some respects. Each gateway may be configured to implement any of the network communication technologies known in the state of the art so the gateway may remotely communicate with processing device 602. Each gateway may be configured with one or more capabilities of a gateway and/or controller as known in the state of the art and may be any of a plurality of types of devices configured to perform the gateway functions defined herein. To ensure security of the transmitted data, each gateway may include a TPM (for example in a hardware layer of a controller). The TPM may be used, for example, to encrypt portions of communications from/to processing device 602 to/from gateways, to encrypt portions of such information received at a gateway unencrypted, or to provide secure communications between the cloud 616, gateways and processing device 602. For example, TPMs or other components may be configured to implement Transport Layer Security (TLS) for HTTPS communications and/or Datagram Transport Layer Security (DTLS) for datagram-based applications. Furthermore, one or more security credentials associated with any of the foregoing data security operations may be stored on a TPM. A TPM may be implemented within any of the gateways, processing device 602 or servers in the cloud 616, for example, during production, and may be used to personalize the gateway or the sensor device. Such gateways, sensor devices and/or servers may be configured (e.g., during manufacture or later) to implement cryptographic technologies known in the state of the art, such as a Public Key Infrastructure (PKI) for the management of keys and credentials.

The system may further comprise a measurement device (not shown), for example a multi-angle spectrophotometer, such that the system may be used to determine the properties of coatings, such as the color data, and to interrelate the determined properties using processor 604 with data associated with the coating material used to prepare the coatings and with application parameters (i.e. parameters used to apply the coating material) and data on the coating material application equipment (i.e. data on the coating material application equipment used to apply the coating material). The obtained data may be used by processor 604 to generate training data sets. The training data sets may be generated as previously described in relation to FIGS. 4, 5A and 5B. The training data sets may be provided via a communication interface to cloud 616, to train the data-driven models 618 to 624 stored in the cloud. The measurement device may be coupled via a communication interface to processing device 602 and may be controlled using input/output device 608. The raw measurement data may either be processed by processor 604 of processing device 602 or by a processor included in the measurement device. In the latter case, the processed data may be provided to processor 604 via the communication interface.

System 600 may further comprise a coating material application equipment (not shown), for example a pneumatic or electrostatic coating material application equipment as described previously, such that the system may be used to apply a coating material using the coating material application equipment. The application equipment may be used to evaluate whether the application parameters determined with the methods disclosed therein, for example the methods described in relation to FIGS. 1 to 3, indeed result in the desired surface properties of the sample coating if the sample coating material is applied to the substrate using the determined application parameters (i.e. the parameters necessary to apply the coating material using the application equipment chosen by a user or determined by the inventive method). Moreover, the coating material application equipment may be used to acquire training data for training the data-driven model by applying a coating material using defined application parameters, interrelating the defined application parameters with determined data associated with the coating, such as color data of the coating and. The application parameters may be further interrelated with data associated with the coating material, such as data related to the properties of the coating material.

Turning to FIG. 7, there is shown an Internet-based system for determining application parameters for applying a sample coating material to at least part of a surface of an object such that the resulting sample coating matches the properties of a reference coating. The system 700 may comprise a server 702 which can be accessed via a network 704, such as the Internet, by one or more clients 706. The server may be an HTTP server and may be accessed via conventional Internet web-based technology. The server may perform the inventive methods disclosed therein, for example the inventive methods described in relation to FIGS. 1 to 5B. The server may be connected to a cloud containing data-driven model(s) as described in relation to FIG. 6. The clients 706 may be computer terminals accessible by a user and may be customized devices, such as data entry kiosks, or general-purpose devices, such as a personal computer. A printer 708 may be connected to a client terminal 706. The internet-based system is in particular useful, if determination of the application parameters is provided as a service to customers or in a larger company setup. Client 706 may be used to provide data or instructions to the computer processor of the server.

FIG. 8A illustrates an example of a planar view of a graphical user interface (GUI) 800a. The GUI may be displayed to a user by a display device. The display device may be an input/output device, for example I/O device 608 described in relation to FIG. 6 or a client device, for example client device 706 described in relation with FIG. 7. The GUI may be displayed to a user upon start of the methods disclosed therein. For instance, the GUI may be displayed upon start of the methods described in relation to FIG. 1. The graphical user interface 800a may be displayed on any device, such as portable and stationary devices, comprising a display. The GUI may be displayed on a computer display. The graphical user interface 800a may include an adjustment tool 816, drop down menus 802, 808, input fields 804, 810, 812, 814, 818, 820 for inputting a variety of data and tables 824, 826 for displaying the determined data associated with the sample coating and the determined application parameters. The data provided by the user in the input fields, drop down menus and via the adjustment tool may be used to determine the application parameters as described in relation to FIGS. 1 to 3.

A user may select the reference coating using drop down menu 802. The reference coating may be selected via the product code associated with the reference coating. The reference coating may be selected via the product code associated with the reference coating material used to prepare the reference coating. Input field 804 may be automatically filled with the color name corresponding to the product code selected in drop down menu 802. This allows the user to check whether the correct product code was selected. The color data, such as the CIEL*a*b* values and CIEL*C*h* values of the reference color, i.e. the reference coating, may be retrieved from a database based on the selected product code and may be displayed in table 806. Threshold values associated with the color values of the reference coating may be retrieved and may be displayed within the GUI (not shown). Data on the coating material application equipment and the application parameters used for applying the reference coating material upon production of the reference coating may be retrieved and may be displayed within the GUI (not shown).

In drop-down menu 808, a user may enter the type of application process which should be used to prepare the sample coating. Application processes may include processes commonly used in the coating of substrates, such as metallic substrates. For instance, application processes may include processes where a primer coating layer is generated prior to application of the color imparting basecoat layer. For instance, application processes may include processes where the primer coating layer is omitted. Application processes may include processes where each coating layer is cured prior to applying the next coating layer. Application processes may include processes where two or more coating layer are jointly cured. In input fields 810, 812 and 814, the user may enter data on the application equipment to be used. Such may include the type of atomizer, the type of the shaping air ring and the type of the bell cup (electrostatic application), or the type of the air cap (pneumatic application).

Adjustment tool 816 has various regulators which may be moved by a computer mouse or a finger (in case the display comprises a touchscreen). Adjustment tool 816 may be used to display the minimum and maximum values associated with the coating material application equipment defined by the user via data entry in fields 808 to 814. All regulators may be set to 0 prior to data entry into fields 808 to 814. Value(s) corresponding to the actual position(s) of the regulator(s) may be displayed above the respective regulator and may be automatically updated during movement of the respective regulator by a user. This may improve user comfort during use of the adjustment tool. The minimum and maximum values shown in adjustment tool 816 may be retrieved from a database based on the data entry performed by the user in fields 808 to 814.

In area 818, the user may select whether a range or a fixed value should be used for the determination of the application parameters by selecting the appropriate check box. The range or fixed value may be selected using the respective regulator(s) of the adjustment tool 818. At least one of the check boxes present in area 818 may be preselected, for example based on the data entered by the user in fields 808 to 814.

Button 822 allows to initiate the methods for determining application parameters as disclosed herein, for example as disclosed in relation to FIGS. 1 to 3. The determination may be based on data selected in adjustment tool 816 and area 818, the target film build entered in text field 820, the color data of the target coating shown in table 806 and threshold value(s) for said color data (not shown in FIG. 8A). The determined application parameters may be provided in column “Prediction” of table 824. Additionally, the determined data associated with the sample coating, such as color data, may be provided in table 826.

The user may download the determined application parameters and optionally further data, such as the determined color data, the target color data, threshold value(s) etc., by clicking on button 828.

FIG. 8B illustrates an example of a planar view of a graphical user interface (GUI) 800b. The GUI may be displayed to a user by a display device. The display device may be an input/output device, for example I/O device 608 described in relation to FIG. 6 or a client device, for example client device 706 described in relation with FIG. 7. The GUI may be displayed to the user after determining the application parameters with the methods disclosed therein, for example with the methods described in relation to FIGS. 1 to 3. This graphical user interface 800b may be displayed on any device, such as portable and stationary devices, comprising a display. The GUI may be displayed on a computer display.

The user has selected the reference coating via drop down menu 802. Field 804 was automatically filled with the color name corresponding to the product code selected in drop down menu 802. The color data, such as CIEL*a*b* values and CIEL*C*H* values of the reference color, i.e. the reference coating, retrieved from a database based on the chosen product code, are displayed in table 806. Threshold values associated with the color values of the reference coating may be retrieved and may be displayed within the GUI (not shown). Data on the coating material application equipment and the application parameters used for applying the reference coating material upon production of the reference coating may be retrieved and may be displayed within the GUI (not shown).

In drop-down menu 808, the user has entered the type of application process which should be performed to produce the sample coating and has provided details on the application equipment to be used, such as the type of atomizer, the type of the shaping air ring and the type of the bell cup (electrostatic application) or the type of the air cap (pneumatic application).

The regulators of adjustment tool 816 have been set to the minimum and maximum values associated with the coating material application equipment defined by the user upon data entry into fields 806 to 814. The minimum and maximum values shown in adjustment tool 816 may be retrieved from a database based on the data entry performed by the user in fields 808 to 814.

In area 818, the user has selected whether a range or a fixed value entered using adjustment tool 816 has been used for the determination of the application parameters by selecting the appropriate check boxes in area 818. The range or fixed value has been entered using the respective regulator(s) of the adjustment tool 818. Moreover, the user has entered the target film thickness in text field 820 and has initiated determination of application parameters according to methods as disclosed herein, for example as disclosed in relation to FIGS. 1 to 3, by clicking on button 822.

The determined application parameters are provided in column “Prediction” of table 824. Additionally, the determined color data is provided in table 626.

The user may download the determined application parameters and optionally further data, such as the determined color data, the target color data, threshold value(s) etc., by clicking on button 828.

The present disclosure has been described in conjunction with preferred embodiments and examples as well. However, other variations can be understood and effected by those persons skilled in the art and practicing the claimed invention, from the studies of the drawings, this disclosure and the claims.

As used herein “determining” also includes “initiating or causing to determine”, “generating” also includes “initiating and/or causing to generate” and “providing” also includes “initiating or causing to determine, generate, select, send and/or receive”. “Initiating or causing to perform an action” includes any processing signal that triggers a computing node or device to perform the respective action.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

Any disclosure and embodiments described herein relate to the methods, the systems, computer programs, computer readable non-volatile storage media, and client devices lined out above and vice versa. Advantageously, the benefits provided by any of the embodiments and examples equally apply to all other embodiments and examples and vice versa.

1. A computer-implemented method for determining application parameters for applying a sample coating material to at least part of a surface of an object such that the resulting sample coating matches the properties of a reference coating, the method comprising the following steps:
(i) providing to a computer processor via a communication interface
data associated with the reference coating, said data including property data of the reference coating and respective threshold value(s) for said property data,
application parameters, wherein the application parameters are randomly generated based on data associated with a coating material application equipment,
data associated with the sample coating material, and
at least one data-driven model, wherein each data-driven model is parameterized according to a training dataset, wherein the training dataset is based on sets of training data comprising application parameters, data associated with coatings and data associated with coating materials,
(ii) determining, with the computer processor, data associated with the sample coating based on the provided data associated with the sample coating material, the provided application parameters and the provided data-driven model(s),
(iii) determining, with the computer processor, the acceptability of the provided application parameters based on the data determined in step (ii) and the data associated with the reference coating provided in step (i),
(iv) optionally determining optimized application parameters and repeating steps (ii) and (iii) using the determined optimized application parameters; and
(v) providing via the communication interface the randomly generated application parameters or the optimized application parameters.

2. The method according to claim 1, wherein the data associated with the reference coating comprises color data obtained for at least one measurement geometry selected from the group consisting of illuminant, gloss-horizontal, gloss-vertical, distinctness of image-horizontal (DOI-H), DOI-vertical; peel-horizontal, peel-vertical, OAR-horizontal, OAR-vertical, pop value, sag value, pinholing value, wet and/or dry film thickness, and any combination thereof.

3. The method according to claim 1, wherein the data associated with the coating material application equipment comprises a range or a specific value for at least one parameter selected from the group consisting of shaping air value(s), flow rate, bell speed, high voltage, distance to object, distance to track and traction speed.

4. The method of according to claim 1, wherein the data associated with the sample coating comprises a number being indicative of the sample coating material used to prepare the sample coating, physical properties of the sample coating material used to prepare the sample coating, chemical properties of the sample coating material used to prepare the sample coating, the film thickness of the sample coating layer or a combination thereof.

5. The method of according to claim 1, wherein the application parameters are randomly generated using uniform sampling methods.

6. The method of according to claim 1, wherein a plurality of data-driven models is provided in step (i), each data-driven model being parametrized on sets of training data comprising application parameters, data associated with coatings and optionally data associated with the coating materials used to prepare the coatings.

7. The method of according to claim 1, wherein determining data associated with the sample coating in step (ii) includes determining colorimetric values for each measurement geometry contained in the data associated with the reference coating provided in step (i).

8. The method of according to claim 1, wherein determining the acceptability of the application parameters based on the data determined in step (ii) and the data associated with the reference coating provided in step (i) includes:
determining the difference(s) between the provided data associated with the reference coating and the determined data associated with the sample coating,
optionally aggregating the determined difference(s) into a single numerical value, and
comparing the determined differences(s) or the single numerical value to the threshold values(s) contained in the provided data associated with the reference coating or to threshold value(s) calculated from the provided data associated with the reference coating.

9. The method of according to claim 1, wherein determining optimized application parameters and repeating steps (ii) and (iii) includes:
determining, with the computer processor, optimized application parameters based on the acceptability determined in step (iii) and the provided application parameters using an optimization algorithm, and
repeating steps (ii) and (iii) using the optimized application parameters until the determined optimized application parameters are determined to be acceptable.

10. The method of according to claim 1, further including the following steps:
(vi) in accordance with the determination that the provided or optimized application parameters are acceptable:
optionally providing via a communication interface to the computer processor a set of defined application parameters,
comparing with the computer processor the acceptable provided or optimized application parameters to the provided set of defined application parameters, and
(vii) in accordance with the determination that the acceptable provided or optimized application parameters match the set of defined application parameters: providing via the communication interface the result of the comparison performed in step (viii), or
(viii) in accordance with the determination that the acceptable provided or optimized application parameters do not match the set of defined application parameters:
modifying the formulation of the sample coating material.

11. An apparatus for determining application parameters for applying a sample coating material to at least part of a surface of an object such that the resulting sample coating layer matches the properties of a reference coating layer, the apparatus comprising one or more computing nodes and one or more computer-readable media having thereon computer-executable instructions that are structured such that, when executed by the one or more computing nodes, cause the apparatus to perform the method of according to claim 1.

12. A computer program or computer readable non-volatile storage medium comprising computer readable instructions, which when loaded and executed by a processing device perform the method according to claim 1.

13. A method for training at least one data-driven model for determining application parameters for applying a sample coating material to at least part of a surface of an object such that the resulting sample coating layer matches the properties of a reference coating layer, the method comprising the steps of:
providing, via a communication interface, at least one training dataset based on sets of training data comprising application parameters, data associated with coatings and data associated with the coating materials used to prepare the coatings,
training, via a processing device, the at least one data-driven model by adjusting the parameterization according to the training dataset(s), and
providing, via the communication interface, the trained data-driven model(s).

14. A computer program product or computer readable non-volatile storage medium comprising the at least one data-driven model trained according to claim 13.

15. A client device for generating a request to initiate the determination of application parameters for applying a sample coating material to at least part of a surface of an object such that the resulting sample coating layer matches the properties of a reference coating layer at a server device, wherein the client device is configured to provide data associated with the reference coating, application parameters and data associated with the sample coating material to the server device and wherein the server device is an apparatus according to claim 11.

16. The method according to claim 1, wherein the data associated with the reference coating comprises color data obtained for a plurality of measurement geometries using at least one illuminant.

17. The method according to claim 1, wherein determining data associated with the sample coating in step (ii) includes determining CIEL*a*b* values and/or CIEL*C*H* values, for each measurement geometry contained in the data associated with the reference coating provided in step (i).
